(19) United States
(12) Patent Application Publication
(10) Pub. No.: US 2021/0327700 A1
(43) Pub. Date: Oct. 21, 2021

(54) RF/DC Cutoff to Reduce Contamination and Enhance Robustness of Mass Spectrometry Systems

(71) Applicant: DH Technologies Development Pte. Ltd., Singapore (SG)

(72) Inventor: James Hager, Mississauga (CA)

(21) Appl. No.: 17/270,485

(22) PCT Filed: Aug. 21, 2019
(86) PCT No.: PCT/IB2019/057052

§ 371 Date: Feb. 23, 2021

Related U.S. Application Data
(60) Provisional application No. 62/722,440, filed on Aug. 24, 2018.

(51) Int. Cl. H01J 49/06; H01J 49/00; H01J 49/24; H01J 49/10

(52) U.S. Cl. CPC H01J 49/063; H01J 49/10; H01J 49/24; H01J 49/0031

(57) ABSTRACT

Systems and methods described herein utilize a multipole ion guide that can receive ions from an ion source for transmission to downstream mass analyzers, while preventing unwanted/interfering/contaminating ions from being transmitted into the high-vacuum chambers of mass spectrometry systems. In various aspects, RF and/or DC signals can be provided to auxiliary electrodes interposed within a quadrupole rod set so as to control or manipulate the transmission of ions from the multipole ion guide.

### RELATED APPLICATION

This application claims priority to U.S. provisional application Ser. No. 62/722,440 filed on Aug. 24, 2018, entitled “RF/DC Cutoff to Reduce Contamination and Enhance Robustness of Mass Spectrometer Systems,” which is incorporated herein by reference in its entirety.

### FIELD

The present disclosure relates to mass spectrometry, and more particularly to methods and apparatus utilizing a multipole ion guide for transmitting ions.

### BACKGROUND

Mass spectrometry (MS) is an analytical technique for determining the elemental composition of test substances with both quantitative and qualitative applications. For example, MS can be used to identify unknown compounds, to determine the isotopic composition of elements in a molecule, and to determine the structure of a particular compound by observing its fragmentation, as well as to quantify the amount of a particular compound in the sample.

In mass spectrometry, sample molecules are generally converted into ions using an ion source and then separated and detected by one or more mass analyzers. For most atmospheric pressure ion sources, ions pass through an inlet orifice prior to entering an ion guide disposed in a vacuum chamber. In conventional mass spectrometry systems, a radio frequency (RF) signal applied to the ion guide provides collisional cooling and radial focusing along the central axis of the ion guide as the ions are transported into a subsequent, lower-pressure vacuum chamber in which the mass analyzer(s) are disposed.

Ionization at atmospheric pressure (e.g., by chemical ionization, electrospray) is generally a highly efficient means of ionizing molecules within the sample. Atmospheric ionization of ions can create analytes of interests, as well as interfering/contaminating ions and neutral molecules in high abundance.

### SUMMARY

The present disclosure encompasses a recognition that there is a need for enhanced ion guides for transmitting ions from an ion source to downstream components of a mass spectrometer. The present disclosure recognizes that because most ion optics (e.g., lenses) of mass spectrometry systems are subject to ion deposition due to the defocusing of ions during their transmission therethrough and as such may exhibit significantly different behavior following substantial contamination (e.g., loss of sensitivity). It can be beneficial to regularly clean fouled surfaces to maintain sensitivity. While the surfaces of front-end components (e.g., curtain plates, orifice plates, front end ion guides, etc.) may be relatively easy to clean, fouling of components contained within downstream high-vacuum chambers (e.g., Q0, Q1, IQ1) can result in time and/or expense as vacuum chambers must be vented and substantially disassembled prior to cleaning. Methods and systems for controlling contamination of components of mass spectrometry systems are provided herein. In some aspects, such methods and systems are operable and particularly useful while maintaining stability of an ion source and/or while continuously producing ions thereby. By reducing transmission of ions into sensitive components housed within a mass spectrometry system, the systems of present disclosure exhibit increased throughput, improved robustness, and/or decreased downtime typically required to vent/disassemble/clean fouled components.

Among other things, the present disclosure encompasses a recognition that mass spectrometry systems as disclosed herein including an auxiliary electrode assembly used in conjunction with an ion guide can reduce downstream contamination of such systems. In some embodiments, the present disclosure provides geometries and biasing approaches for such ion guides and auxiliary electrode assemblies. In some embodiments, the present disclosure provides methods of making and using such assemblies. Implementations of auxiliary electrode assemblies of the present disclosure are useful in mass spectrometry systems, including, for example when sampling complex high molecular weight biologics.

In some embodiments, the present disclosure provides a mass spectrometry system including an ion source and an ion guide. Ion sources generate ions and an ion guide positioned downstream of the ion source can be configured for receiving, selecting, channeling, and/or transmitting the generated ions to a mass analyzer that is positioned downstream from an ion source and an ion guide in the mass spectrometry system. In some embodiments, the ion guide is disposed in a chamber having an inlet orifice and at least one exit orifice. The ion guide chamber's inlet orifice receives ions generated by the ion source. In some embodiments, the ion guide chamber is or can be maintained at a pressure in a range from about 1 mTorr to about 30 mTorr. In some embodiments, the ion guide chamber is or can be maintained at a pressure such that pressure×quadrupole rod length is greater than 2.25×10⁻² Torr-cm. In some embodiments, the ion guide chamber's at least one exit orifice transmits a portion of the ions received from the ion source into a vacuum chamber housing at least one mass analyzer.

In some embodiments, the present disclosure provides a mass spectrometry system including a vacuum chamber that can house at least one mass analyzer. In some embodiments, the vacuum chamber housing the at least one mass analyzer is positioned downstream from the ion guide chamber and can be fluidly connected thereto. The mass analyzer vacuum chamber is or can be maintained at a low pressure. For example, the vacuum chamber housing the mass analyzer can be maintained at a lower pressure than the ion guide chamber to which it is connected, that is for example, the low pressure of the mass analyzer vacuum chamber is less than about 1×10⁻⁴ Torr, such as about 5×10⁻⁵ Torr. Mass analyzers can include, for example: triple quadrupoles, linear ion traps, quadrupole time of flights, Orbitrap, or other Fourier transform mass spectrometry systems, etc.

In some embodiments, an ion guide is a multipole ion guide. A multipole ion guide is or can be disposed in an ion guide chamber. In some embodiments, a multipole ion guide can include a quadrupole rod set extending from a proximal end of the ion guide chamber disposed adjacent to the inlet orifice to a distal end of the ion guide chamber disposed adjacent to the at least one exit orifice. The quadrupole rod set can include a first pair of rods and a second pair of rods. Each rod of the quadrupole rod set can be spaced from and extend alongside a central longitudinal axis of an ion guide chamber.

In some embodiments, an ion guide chamber can include an auxiliary electrode assembly. In some embodiments, the auxiliary electrode assembly can include a plurality of auxiliary electrodes. In some embodiments, auxiliary electrodes of the plurality of auxiliary electrodes are spaced from and extend alongside a central longitudinal axis of the ion guide chamber. In some embodiments, the auxiliary electrodes can include first and second pairs of auxiliary electrodes. In some embodiments, first and second pairs of auxiliary electrodes are arranged in relation to a central longitudinal axis of the ion guide chamber. By way of example, auxiliary electrodes of the first pair can be arranged radially opposite from one another around the central longitudinal axis. In another example, an auxiliary electrode of a first pair of auxiliary electrodes can be arranged radially opposite an auxiliary electrode of a second pair. That is, both auxiliary electrodes of the first pair are arranged radially adjacent to one another with respect to the central longitudinal axis.

In some embodiments, the auxiliary electrode assembly can include at least one auxiliary electrode that is positioned between rods of the quadrupole rod set. In some embodiments, a plurality of auxiliary electrodes are spaced from and extend alongside at least a portion of the first and second pairs of rods of the quadrupole rod set that is disposed within the ion guide chamber. For example, auxiliary electrodes of the plurality of auxiliary electrodes can be interposed between rods of the quadrupole rod set. In some embodiments, one auxiliary electrode is positioned adjacent to a quadrupole rod from the first pair of quadrupole rods of the quadrupole rod set and a quadrupole rod from the second pair of quadrupole rods of the quadrupole rod set. In some embodiments, one quadrupole rod is positioned adjacent to an auxiliary electrode from each of the first and second pairs of auxiliary electrodes.

Auxiliary electrodes of a plurality of auxiliary electrodes can be characterized by a thickness, for example a thickness range of about 0.1 mm to about 50 mm. The auxiliary electrodes can also be characterized by their length. For example, auxiliary electrodes can extend along at least a portion of a length of a quadrupole rod of the quadrupole rod. Auxiliary electrodes could also fully extend along the length of a quadrupole rod of the quadrupole rod set. In some embodiments, each auxiliary electrodes' length is less than that length of the quadrupole rods of the quadrupole rod set. For example, the auxiliary electrodes can have a length less than half of the length of a quadrupole rod of the quadrupole rod set (e.g., less than 33%, less than 10%). In some embodiments, the auxiliary electrodes can be positioned at various locations along the length of the quadrupole rods of the quadrupole rod set (e.g., in one or more of a proximal third, a middle third, or a distal third of a quadrupole rod set). Auxiliary electrodes can have a variety of configurations. In some embodiments, auxiliary electrodes can have a round shape or a T-shape configuration. T-shaped auxiliary electrodes can have a constant T-shaped cross sectional area along their entire length. In some embodiments, a plurality of auxiliary electrodes further include a plurality of electrically conductive stems having a length of about 5 mm to about 20 mm. In some embodiments, auxiliary electrode stems extend alongside the pairs of rods of the quadrupole rod set and can be radially arranged about a central axis of a ion guide.

In some embodiments, an auxiliary electrode assembly can further include an electrically conductive collar that can be configured such that each auxiliary electrode is electrically coupled to the others. In some embodiments, an auxiliary electrode assembly can include auxiliary electrodes that are electrically isolated from one another. In some embodiments, auxiliary electrodes are electrically coupled in pairs. In some embodiments, the coupled pairs of auxiliary electrodes are isolated from one another. For example, first and second pairs of auxiliary electrodes are configured such that the auxiliary electrodes of the first pair are electrically coupled, the and auxiliary electrodes of the second pair are electrically coupled, and the first and second pairs are electrically isolated from one another.

In some embodiments, a mass spectrometry system as provided herein can include at least one power supply coupled to the multipole ion guide. At least one power supply is in electrical communication with the rods of a quadrupole rod set and configured to apply electrical power to the rods. In some embodiments, the at least one power supply can include one or more RF sources that are configured to apply a first RF voltage to the first pair of quadrupole rods and a second RF voltage to the second pair of quadrupole rods. In some embodiments, the first RF voltage is applied to the first pair of quadrupole rods at a first frequency and in a first phase and the second RF voltage is applied to the second pair of quadrupole rods at a second frequency that is equal to the first frequency and in a second phase that is opposite to the first phase. In some embodiments, a power supply can include at least one DC voltage source operable to apply a DC offset voltage to the quadrupole rod set. In some embodiments, the DC offset voltage can include first and second DC voltages applied to first and second pairs of quadrupole rods of the quadrupole rod set. In some embodiments, first and second applied DC voltages have substantially the same amplitude. In some embodiments, a power supply can be configured to provide a supplemental electrical signal to at least one quadrupole rod of a quadrupole rod set. In some embodiments, the supplemental electrical signal is one of a DC voltage and/or an AC excitation signal. For example, the power supply can be operable to provide a supplemental electrical signal to a quadrupole rod set so as to generate a dipolar DC field, a quadrupolar DC field, or resonance excitation using a supplementary AC field that is resonant or nearly resonant with some of ions in an ion beam.

In some embodiments, at least one power supply is in electrical communication with the auxiliary electrodes and can be configured to apply electrical power to auxiliary electrodes disposed in the ion guide chamber. For example, the power supply can be operable to provide a first electrical signal to each auxiliary electrode of a first pair of auxiliary electrodes, and a second auxiliary electrical signal to each auxiliary electrode of a second pair of auxiliary electrodes. In some embodiments, the first and second signals are substantially the same. In some embodiments, the first and second signals are different. For example, the first and second auxiliary signals applied to the first and second set of auxiliary electrodes can include a first DC voltage source configured to apply a DC voltage to the first pair of auxiliary electrodes and a second DC voltage source configured to apply a DC voltage to the second pair of auxiliary electrodes. In some embodiments, first and second DC voltages applied to first and second auxiliary electrodes have an amplitude that is different from a DC offset voltage applied to the rods of the quadrupole rod set. In some embodiments, the at least one power supply can be operable to provide a first DC voltage to a first pair of the auxiliary electrodes and a second DC voltage to a second pair of the auxiliary electrodes where the first and second DC voltages have the same amplitude and have opposite signs. In some embodiments, the first and second DC voltages have the same amplitude and the same sign.

In some embodiments, applied auxiliary DC voltages can have an amplitude in a range of about ±1 V to about ±200 V. In some embodiments, RF voltages can have an amplitude in a range of about 50 V to about 1000 V. In some embodiments, RF voltages can have a frequency in a range of about 0.3 MHz to about 2.5 MHz.

In some embodiments, a mass spectrometry system as provided herein can include at least one controller coupled to a multipole ion guide. In some embodiments, the at least one controller is in communication with at least one power supply. In some embodiments, at least one controller is in communication with a quadrupole rod set of a multipole ion guide. In some embodiments, at least one controller is in communication with a plurality of auxiliary electrodes of a multipole ion guide. In some embodiments, at least one controller can be configured to adjust, control, or regulate power applied to the quadrupole rod set and/or the plurality of auxiliary electrodes.

In some embodiments, at least one controller can be configured to adjust, control, or regulate power applied to a plurality of auxiliary electrodes. For example, the at least one controller can be configured to adjust, control, or regulate power applied to first and second pairs of auxiliary electrodes such that ions entering a multipole ion guide are attenuated, cut off, filtered or removed from an ion beam before reaching downstream mass spectrometry system components. In some embodiments, the controller can be configured to adjust, control, or regulate DC voltages and/or RF voltages that are applied to the auxiliary electrodes. For example, the controller can be configured to control the DC voltages applied to the first and second auxiliary electrodes so that these voltages differ from the DC offset voltage at which the quadrupole rod set is maintained. In some embodiments, the controller can be configured to maintain the first and second applied auxiliary DC voltages at substantially the same amplitude or magnitude or at a different amplitude or magnitude. In some embodiments, the controller can be configured to maintain first and second applied auxiliary DC voltages at substantially the same amplitude or magnitude but with opposite signs. In some embodiments, the controller can be configured to adjust, control, or regulate the first and second auxiliary DC voltages that are applied to the auxiliary electrodes relative to the DC offset voltage that is applied to the at least one rod of a quadrupole rod set so as to attenuate, cutoff, and/or filter at least a portion of ions that are transmitted from a multipole ion guide. Ion transmission downstream of the ion guide can be attenuated, cutoff, and/or filtered when the controller adjusts the first and second auxiliary DC voltages that are applied to auxiliary electrodes relative to the DC offset voltage that is applied to at least one rod of a quadrupole rod set. In some embodiments, the ion cutoff can be configured to occur according to ion m/z. For example, the controller can be configured to adjust the first and second auxiliary DC voltages that are applied to the auxiliary electrodes relative to the DC offset voltage that is applied to the rods of the quadrupole rod set such that a high m/z ion cutoff is achieved, whereby the cutoff can limit or substantially prevent exposure of downstream optic to these high m/z ions. In some embodiments, the controller can be configured to adjust, control, or regulate first and second auxiliary voltages by configuring a multipole ion guide to transmit less than 15%, less than 10%, less than 5%, less than 2%, less than 1%, or 0% of ions received from an ion source. In some embodiments, high m/z ion cutoff can be at about 400-2000 amu.

In some aspects, the present disclosure further provides methods of processing ions, which can include receiving ions generated by an ion source through an inlet orifice of an ion guide chamber and selecting, channeling, and/or transmitting ions through a multipole ion guide disposed in the ion guide chamber so that selected ions reach a downstream mass analyzer. In some embodiments, methods of selecting, channeling, and/or transmitting ions include providing a multipole ion guide according to various embodiments disclosed herein. In some embodiments, methods of selecting, channeling, and/or transmitting ions through the multipole ion guide can include applying power to quadrupole rods sets and/or applying power to an auxiliary electrode assembly. For example, methods can include applying a first RF voltage to a first pair of rods of the quadrupole rod set at a first frequency and in a first phase and applying a second RF voltage to the second pair of rods of the quadrupole rod set at a second frequency. The first frequency can be the same or different from the second frequency. The first and second phase can be the same or opposite one another.

In some embodiments, methods can include applying power to auxiliary electrodes of an auxiliary electrode assembly. For example, methods can include applying a DC voltage to first and second auxiliary electrodes. Applying a DC voltage to the first and second auxiliary electrodes can include applying a first DC voltage to the first auxiliary electrode and a second DC voltage to the second auxiliary electrode, where the first and second voltages can include the same or a different amplitude, frequency and/or phase. In some embodiments, methods can include applying the first and second DC voltages such that they are different from the DC offset voltage at which a quadrupole rod set is maintained. In some embodiments, the present disclosure provides methods of adjusting, controlling, and/or regulating the first and second auxiliary DC voltages applied to first and second auxiliary electrodes relative to the DC offset voltage at which a quadrupole rod set is maintained in order to attenuate, filter, and/or generate a cutoff of ions transmitted from the multipole ion guide. In some embodiments, the cutoff of ions is according to their m/z. In some embodiments, the ion cutoff can be a cutoff of high mass ions. For example, methods can include adjusting, controlling, and/or regulating first and second auxiliary electrodes to be attractive relative to a DC offset, so that a high m/z ion cutoff is generated.

By way of example, methods can include adjusting, controlling, and/or regulating the first and second auxiliary DC voltages applied to first and second auxiliary electrodes relative to the DC offset voltage at which a quadrupole rod set is maintained. In some embodiments, the DC voltages applied to the first and second auxiliary electrodes can have the same amplitude but opposite signs in order to attenuate (i.e., to reduce ion current), filter, and/or generate a cutoff of ions transmitted from the multipole ion guide (i.e., adjust a m/z range of ions transmitted from a multipole ion guide). In some embodiments, methods provided herein further include adjusting, attenuating, filtering, and/or preventing transmission of ions received by a multipole ion guide by adjusting, controlling, and/or regulating the RF voltage applied to a first pair of rods of the quadrupole rod set and/or the RF voltage applied to a second pair of rods of the quadrupole rod set.

In some embodiments, methods can include applying a supplemental electrical signal to at least one rod of a quadrupole rod set. In some embodiments, a supplemental electrical signal is one of a DC voltage and/or an AC excitation signal and can be effective to generate a dipolar DC field, a quadrupolar DC field, or resonance excitation using a supplementary AC field that is resonant or nearly resonant with at least some ions in an ion beam.

In some embodiments, methods of the present disclosure can include maintaining an ion guide chamber at a pressure in a range from about 1 mTorr to about 30 mTorr. For example, methods can include maintaining the ion guide chamber at a pressure such that pressure×length of quadrupole rods that is greater than 2.25×10⁻² Torr-cm. In some embodiments, methods can include maintaining an ion guide chamber pressure higher than that of a downstream vacuum chamber, for example, at about 1×10⁻⁴ Torr, about 5×10⁻⁵, or less.

The foregoing and other advantages, aspects, embodiments, features, and objects of the present disclosure will become more apparent and better understood by referring to the following detailed description when read in connection with the accompanying drawing.

### BRIEF DESCRIPTION OF THE DRAWING

A person of ordinary skill in the art will understand that the drawing, described below, is for illustration purposes only. The figures of the drawing are not intended to limit the scope of the Applicant's teachings in any way. It is emphasized that, according to common practice, various features of the drawing are not to scale. On the contrary, the dimensions of the various features are or may be arbitrarily expanded or reduced for clarity. Included in the drawing are the following Figs.:

FIG. 1, in a schematic diagram, illustrates a mass spectrometry system that can include a multipole ion guide having auxiliary electrodes in accordance with one aspect of various embodiments of the applicant's teachings;

FIG. 2, in schematic diagram, depicts a cross-sectional view of an exemplary multipole ion guide in accordance with various aspects of the present teachings for use in the mass spectrometry system of FIG. 1;

FIG. 3 depicts an exemplary prototype of a portion of a multipole ion guide of FIG. 2;

FIG. 4A depicts exemplary data for an ion having a m/z of 322 Da processed by a mass spectrometry system in accordance with various aspects of the present teachings;

FIG. 4B depicts exemplary data for an ion having a m/z of 622 Da processed by a mass spectrometry system in accordance with various aspects of the present teachings;

FIG. 4C depicts exemplary data for an ion having a m/z of 922 Da processed by a mass spectrometry system in accordance with various aspects of the present teachings;

FIGS. 5A-C depict exemplary mass spectra generated by a mass spectrometry system for processing ions in accordance with various aspects of the present teachings;

FIGS. 6A-D depict exemplary mass spectra generated by a mass spectrometry system for processing ions in accordance with various aspects of the present teachings;

FIGS. 7A-C depict exemplary mass spectra generated by a mass spectrometry system for processing ions in accordance with various aspects of the present teachings;

FIGS. 8A-F depict exemplary mass spectra generated by a mass spectrometry system for processing ions in accordance with various aspects of the present teachings;

FIG. 9, in schematic diagram, depicts a cross-sectional view of an exemplary multipole ion guide in accordance with various aspects of the present teachings for use in the mass spectrometry system of FIG. 1;

FIG. 10, in schematic diagram, depicts an attractive potential well that arises when the RF/DC filter is biased attractively;

FIG. 11, in schematic diagram, depicts repulsive axial barrier that arises when the RF/DC filter is biased repulsively;

FIG. 12 depicts exemplary data for an extracted ion chromatogram of m/z 564 obtained with two different ion beam intensities;

FIG. 13 depicts an exemplary prototype of a portion of a multipole ion guide of FIG. 2 and FIG. 9;

FIG. 14, in schematic diagram, depicts a cross-sectional view of another exemplary multipole ion guide in accordance with various aspects of the present teachings for use in the mass spectrometry system of FIG. 1;

FIG. 15, in schematic diagram, depicts a cross-sectional view of another exemplary multipole ion guide in accordance with various aspects of the present teachings for use in the mass spectrometry system of FIG. 1; and

FIG. 16 depicts exemplary data for DC voltages applied to the RF/DC filter biased according to FIG. 14.

### DEFINITIONS

Various terms relating to aspects of the present disclosure are used throughout the specification and claims. In order for the present disclosure to be more readily understood, certain terms are first defined below. Additional definitions for the following terms and other terms are set forth throughout the specification.

As used herein, the terms “about”, “approximately”, and “substantially”, refer to variations in a numerical quantity that can occur, for example, through measuring or handling procedures in the real world; through inadvertent error in these procedures; through differences/faults in the manufacture of electrical elements; through electrical losses; as well as variations that would be recognized by a person of ordinary skill in the art as being equivalent so long as such variations do not encompass known values practiced by the prior art. Whether or not modified by the term “about”, “approximately”, or “substantially”, quantitative values recited in the claims include equivalents to the recited values, e.g., variations in the numerical quantity of such values that can occur, but would be recognized to be equivalents by a person skilled in the art.

As used herein, unless otherwise clear from context, the term “a” may be understood to mean “at least one.” As used in this application, the term “or” may be understood to mean “and/or.” In this application, the terms “comprising” and “including” may be understood to encompass itemized components or steps whether presented by themselves or together with one or more additional components or steps. Unless otherwise stated, the terms “about” and “approximately” may be understood to permit standard variation as would be understood by those of ordinary skill in the art. Where ranges are provided herein, the endpoints are included. As used in this application, the term “comprise” and variations of the term, such as “comprising” and “comprises,” are not intended to exclude other additives, components, integers or steps.

As used herein, the terms “about” and “approximately” are used as equivalents. Any numerals used in this application with or without about/approximately are meant to cover any normal fluctuations appreciated by one of ordinary skill in the relevant art. In certain embodiments, the term “approximately” or “about” refers to a range of values that fall within 25%, 20%, 19%, 18%, 17%, 16%, 15%, 14%, 13%, 12%, 11%, 10%, 9%, 8%, 7%, 6%, 5%, 4%, 3%, 2%, 1%, or less in either direction (greater than or less than) of the stated reference value unless otherwise stated or otherwise evident from the context (except where such number would exceed 100% of a possible value). For example, if the term “about” means greater or lesser than the value or range of values stated by 1/10 of the stated value, e.g., ±10%, then applying a voltage of about +3V DC to an element can mean a voltage between +2.7V DC and +3.3V DC.

As used herein, the term “substantially” refers to a qualitative condition of exhibiting total or near-total extent or degree of a characteristic or property of interest. One of ordinary skill in the art will understand that electrical properties rarely, if ever, go to completion and/or proceed to completeness or achieve or avoid an absolute result. Substantially is therefore used herein to capture a potential lack of completeness inherent therein. Values may differ in a range of values within 25%, 20%, 19%, 18%, 17%, 16%, 15%, 14%, 13%, 12%, 11%, 10%, 9%, 8%, 7%, 6%, 5%, 4%, 3%, 2%, 1%, or less in either direction (greater than or less than). For example, values may differ by 5%.

### DETAILED DESCRIPTION

It will be appreciated that for clarity, the following discussion will explicate various aspects of embodiments of the applicant's teachings, while omitting certain specific details wherever convenient or appropriate to do so. For example, discussion of like or analogous features in alternative embodiments may be somewhat abbreviated. Well-known ideas or concepts may also for brevity not be discussed in any great detail. The skilled person will recognize that some embodiments of the applicant's teachings may not require certain of the specifically described details in every implementation, which are set forth herein only to provide a thorough understanding of the embodiments. Similarly it will be apparent that the described embodiments may be susceptible to alteration or variation according to common general knowledge without departing from the scope of the disclosure. The following detailed description of embodiments is not to be regarded as limiting the scope of the applicant's teachings in any manner.

Because ionization at atmospheric pressure (e.g., by chemical ionization, electrospray) is generally a highly efficient means of ionizing molecules within a sample, ions of analytes of interests, as well as interfering/contaminating ions and neutral molecules, can be created in high abundance. The present disclosure encompasses a recognition that although it may be desirable to increase the size of an inlet orifice between an ion source and an ion guide to increase a number of ions of interest entering an ion guide (thereby potentially increasing the sensitivity of MS instruments), such a configuration can likewise allow more unwanted molecules to enter a downstream vacuum chamber and potentially downstream mass analyzer stages located inside high-vacuum chambers where trajectories of the ions of interest are precisely controlled by electric fields. Transmission of undesired ions and neutral molecules can foul/contaminate these downstream elements, thereby interfering with mass spectrometric analysis and/or leading to increased costs or decreased throughput necessitated by the cleaning of critical components within the high-vacuum chamber(s). Because of higher sample loads and contaminating nature of the biologically-based samples being analyzed with current day atmospheric pressure ionization sources, maintaining a clean mass analyzer remains a critical concern.

As discussed below in more detail, in some embodiments, a multipole-ion guide for use in a mass spectrometry system is disclosed, which can include a set of multipole ion guide rods, e.g. a quadrupole rods set, and a plurality of auxiliary electrode that can be interspersed among the rods of the quadrupole rod set. In some such embodiments, two pairs of auxiliary electrodes are disposed between pairs of rods of a quadrupole rode set. It has been discovered that varied designs and arrangements of the application of DC voltages to the pairs of auxiliary electrodes and the quadrupole rods can provide certain advantages. For example, a first DC voltage applied to a first pair of auxiliary electrodes can have a first magnitude, frequency and phase and a second DC voltage applied to a second pair of auxiliary electrodes can have a second magnitude, frequency and phase. A DC offset voltage can be also applied to the rods of the quadrupole rod set. When the first and second applied DC voltages have the same magnitude applied to each of the first and second auxiliary electrodes and that DC voltage differs from the DC offset voltage applied to the rods of the quadrupole rod set, an ion cutoff is generated. For example, such an arrangement can be capable of eliminating high m/z ions from a downstream ion transmission. Such an arrangement can also generate a potential barrier or a potential well that can delay ion passage and can result for example in ion signal instability. Further, when the DC voltages to the first and second pairs of auxiliary electrodes are applied with the sign of the first voltage opposite of that of the sign of the second voltage, the instability can be reduced or eliminated resulting in a high m/z cutoff.

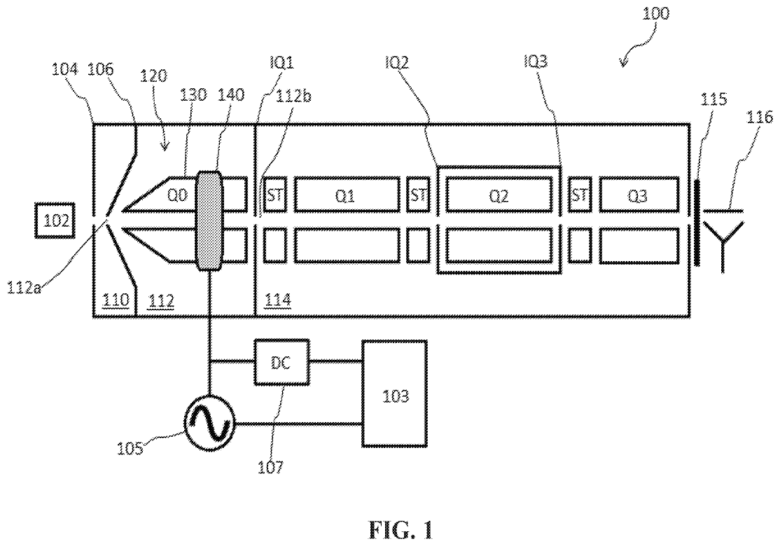

While systems, devices, and methods described herein can be used in conjunction with many different mass spectrometry systems, an exemplary mass spectrometry system 100 for such use is illustrated schematically in FIG. 1. It should be understood that mass spectrometry system 100 represents only one possible mass spectrometry system for use in accordance with embodiments of systems, devices, and methods described herein. Moreover, other mass spectrometry systems having other configurations can all be used in accordance with the systems, devices and methods described herein as well.

As shown schematically in the exemplary embodiment depicted in FIG. 1, the mass spectrometry system 100 generally can include a QTRAP® Q-q-Q hybrid linear ion trap mass spectrometry system, as generally described in an article entitled “Product ion scanning using a Q-q-Qₗᵢₙₑₐᵣ ion trap (Q TRAP®) mass spectrometer,” authored by James W. Hager and J. C. Yves Le Blanc and published in Rapid Communications in Mass Spectrometry (2003; 17: 1056-1064), which is hereby incorporated by reference in its entirety, and modified in accordance with various aspects of the present teachings. Other non-limiting, exemplary mass spectrometry systems that can be modified in accordance with the systems, devices, and methods disclosed herein can be found, for example, in U.S. Pat. No. 7,923,681, entitled “Collision Cell for Mass Spectrometer,” which is hereby incorporated by reference in its entirety. Other configurations, including but not limited to those described herein and others known to those skilled in the art, can also be utilized in conjunction with the systems, devices, and methods disclosed herein.

As shown in FIG. 1, the exemplary mass spectrometry system 100 can include an ion source 102, a multipole ion guide 120 (i.e., Q0) housed within a first vacuum chamber 112, one or more mass analyzers housed within a second vacuum chamber 114, and a detector 116. It will be appreciated that though the exemplary second vacuum chamber 114 houses three mass analyzers (i.e., elongated rod sets Q1, Q2, and Q3 separated by orifice plates IQ2 between Q1 and Q2, and IQ3 between Q2 and Q3), more or fewer mass analyzer elements can be included in systems in accordance with the present teachings. For convenience, the elongated rod sets Q1, Q2, and Q3 are generally referred to herein as quadrupoles (that is, they have four rods), though the elongated rod sets can be any other suitable multipole configurations, for example, hexapoles, octapoles, etc. It will also be appreciated that the one or more mass analyzers can be any of triple quadrupoles, linear ion traps, quadrupole time of flights, Orbitrap or other Fourier transform mass spectrometry systems, all by way of non-limiting example.

As shown in FIG. 1, the exemplary mass spectrometry system 100 can additionally include one or more power supplies (e.g., RF power supply 105 and DC power supply 107) that can be controlled by a controller 103 so as to apply electric potentials with RF, AC, and/or DC components to the quadrupole rods, the various lenses, and the auxiliary electrodes to configure the elements of the mass spectrometry system 100 for various different modes of operation depending on the particular MS application. It will be appreciated that the controller 103 can also be linked to the various elements in order to provide joint control over the executed timing sequences. Accordingly, the controller can be configured to provide control signals to the power source(s) supplying the various components in a coordinated fashion in order to control the mass spectrometry system 100 as otherwise discussed herein.

Q0, Q1, Q2, and Q3 can be disposed in adjacent chambers that are separated, for example, by aperture lenses IQ1, IQ2, and IQ3, and are evacuated to sub-atmospheric pressures as is known in the art. By way of example, a mechanical pump (e.g., a turbo-molecular pump) can be used to evacuate the vacuum chambers to appropriate pressures. An exit lens 115 can be positioned between Q3 and the detector 116 to control ion flow into the detector 116. In some embodiments, a set of stubby rods can also be provided between neighboring pairs of quadrupole rod sets to facilitate the transfer of ions between quadrupoles. The stubby rods can serve as a Brubaker lens and can help minimize interactions with any fringing fields that may have formed in the vicinity of an adjacent lens, for example, if the lens is maintained at an offset potential. By way of non-limiting example, FIG. 1 depicts stubby rods ST between IQ1 and Q1 to focus the flow of ions into Q1. Similarly, stubby rods ST are included upstream and downstream of the elongated rod set Q2, for example.

The ion source 102 can be any known or hereafter developed ion source for generating ions and modified in accordance with the present teachings. Non-limiting examples of ion sources suitable for use with the present teachings include atmospheric pressure chemical ionization (APCI) sources, electrospray ionization (ESI) sources, continuous ion source, a pulsed ion source, an inductively coupled plasma (ICP) ion source, a matrix-assisted laser desorption/ionization (MALDI) ion source, a glow discharge ion source, an electron impact ion source, a chemical ionization source, or a photo-ionization ion source, among others.

During operation of the mass spectrometry system 100, ions generated by the ion source 102 can be extracted into a coherent ion beam by passing successively through apertures in an orifice plate 104 and a skimmer 106 (i.e., inlet orifice 112a) to result in a narrow and highly focused ion beam. In various embodiments, an intermediate pressure chamber 110 can be located between the orifice plate 104 and the skimmer 106 that can be evacuated to a pressure approximately in the range of about 1 Torr to about 4 Torr, though other pressures can be used for this or for other purposes. In some embodiments, the ions can traverse one or more additional vacuum chambers and/or quadrupoles (e.g., a QJet® quadrupole or other RF ion guide) to provide additional focusing of and finer control over the ion beam using a combination of gas dynamics and radio frequency fields.

Ions generated by the ion source 102 are transmitted through an inlet orifice 112a to enter a multipole ion guide 120 (i.e., Q0), which in accordance with the present teachings, can be operated to transmit a portion of the ions received from an ion source 102 into downstream mass analyzers for further processing, while preventing unwanted ions (e.g., interfering/contaminating ions, high-mass ions) from being transmitted into the lower pressures of the vacuum chamber 114. For example, in accordance with various aspects of the present teachings and as discussed in detail below, the multipole ion guide 120 can include quadrupole rods 130a, 130b of the quadrupole rod set and a plurality of auxiliary electrodes 140 extending along a portion of the multipole ion guide 120 and interposed between quadrupole rods 130a, 130b of the quadrupole rod set such that upon application of various RF and/or DC potentials to the components of the multipole ion guide 120, ions of interest are collisionally cooled (e.g., in conjunction with the pressure of vacuum chamber 112) and transmitted through the exit aperture 112b into the downstream mass analyzers for further processing, while unwanted ions can be neutralized within the multipole ion guide 120, thereby reducing a potential source of contamination and/or interference in downstream processing steps. The vacuum chamber 112, within which the multipole ion guide 120 is housed, can be associated with a mechanical pump (not shown) operable to evacuate the chamber to a pressure suitable to provide collisional cooling. For example, the vacuum chamber can be evacuated to a pressure approximately in the range of about 1 mTorr to about 30 mTorr, though other pressures can be used for this or for other purposes. For example, in some aspects, the vacuum chamber 112 can be maintained at a pressure such that pressure×length of the quadrupole rods is greater than 2.25×10⁻² Torr-cm. A lens IQ1 (e.g., an orifice plate) can be disposed between the vacuum chamber of Q0 and the adjacent chamber to isolate the two chambers 112, 114.

After being transmitted from Q0 through the exit aperture 112b of the lens IQ1, the ions can enter the adjacent quadrupole rod set Q1, which can be situated in a vacuum chamber 114 that can be evacuated to a pressure than can be maintained lower than that of ion guide chamber 112. By way of non-limiting example, the vacuum chamber 114 can be maintained at a pressure less than about 1×10⁻⁴ Torr (e.g., about 5×10⁻⁵ Torr), though other pressures can be used for this or for other purposes. As will be appreciated by a person of skill in the art, the quadrupole rod set Q1 can be operated as a conventional transmission RF/DC quadrupole mass filter that can be operated to select an ion of interest and/or a range of ions of interest. By way of example, the quadrupole rod set Q1 can be provided with RF/DC voltages suitable for operation in a mass-resolving mode. As should be appreciated, taking the physical and electrical properties of Q1 into account, parameters for an applied RF and DC voltage can be selected so that Q1 establishes a transmission window of chosen m/z ratios, such that these ions can traverse Q1 largely unperturbed. Ions having m/z ratios falling outside the window, however, do not attain stable trajectories within the quadrupole and can be prevented from traversing the quadrupole rod set Q1. It should be appreciated that this mode of operation is but one possible mode of operation for Q1. By way of example, the lens IQ2 between Q1 and Q2 can be maintained at a much higher offset potential than Q1 such that the quadrupole rod set Q1 be operated as an ion trap. In such a manner, the potential applied to the entry lens IQ2 can be selectively lowered (e.g., mass selectively scanned) such that ions trapped in Q1 can be accelerated into Q2, which could also be operated as an ion trap, for example.

Ions passing through the quadrupole rod set Q1 can pass through the lens IQ2 and into the adjacent quadrupole rod set Q2, which as shown can be disposed in a pressurized compartment and can be configured to operate as a collision cell at a pressure approximately in the range of from about 1 mTorr to about 30 mTorr, though other pressures can be used for this or for other purposes. A suitable collision gas (e.g., nitrogen, argon, helium, etc.) can be provided by way of a gas inlet (not shown) to thermalize and/or fragment ions in the ion beam. In some embodiments, application of suitable RF/DC voltages to the quadrupole rod set Q2 and entrance and exit lenses IQ2 and IQ3 can provide optional mass filtering.

Ions that are transmitted by Q2 can pass into the adjacent quadrupole rod set Q3, which is bounded upstream by IQ3 and downstream by the exit lens 115. As will be appreciated by a person skilled in the art, the quadrupole rod set Q3 can be operated at a decreased operating pressure relative to that of Q2, for example, less than about 1×10⁻⁴ Torr (e.g., about 5×10⁻⁵ Torr), though other pressures can be used for this or for other purposes. As will be appreciated by a person skilled in the art, Q3 can be operated in a number of manners, for example as a scanning RF/DC quadrupole or as a linear ion trap. Following processing or transmission through Q3, the ions can be transmitted into the detector 116 through the exit lens 115. The detector 116 can then be operated in a manner known to those skilled in the art in view of the systems, devices, and methods described herein. As will be appreciated by a person skill in the art, any known detector, modified in accord with the teachings herein, can be used to detect the ions.

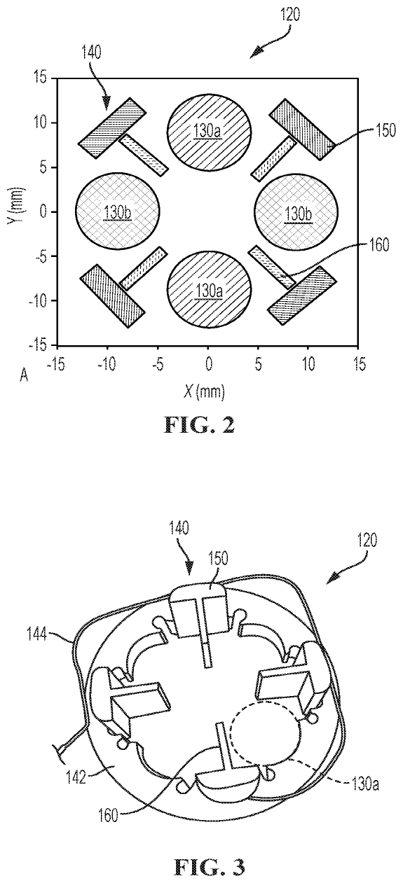

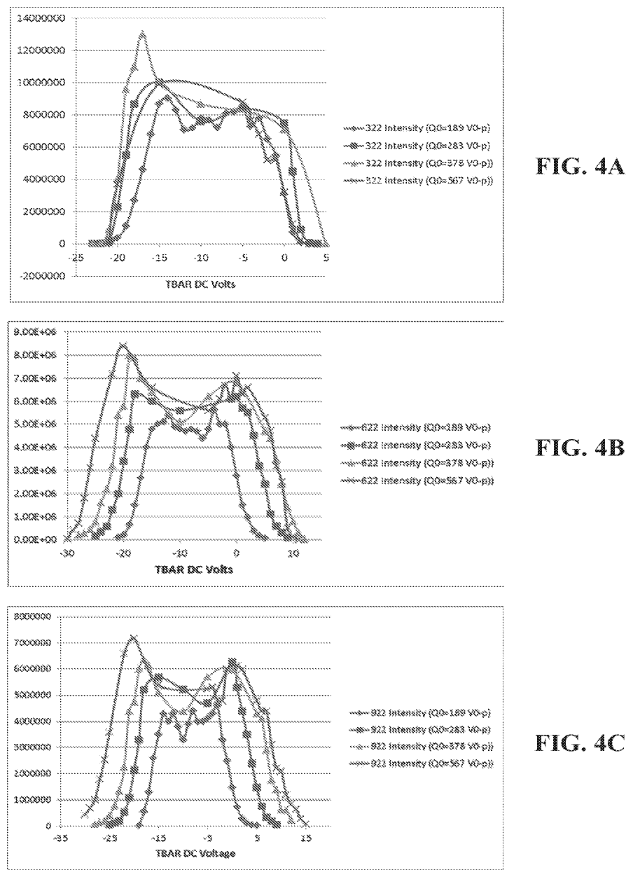

Referring now to FIGS. 2 and 3, the exemplary multipole ion guide 120 of FIG. 1 is depicted in more detail. First, with respect to FIG. 2, the multipole ion guide 120 is depicted in cross-sectional schematic view across the location of the auxiliary electrodes 140 depicted in FIG. 1. As shown and noted above, the multipole ion guide 120 generally can include a set of four rods 130a, 130b that extend from a proximal, inlet end disposed adjacent the inlet orifice 112a to a distal, outlet end disposed adjacent the exit aperture 112b. The rods 130a, 130b surround and extend along the central axis of the multipole ion guide 120, thereby defining a space through which the ions are transmitted. As is known in the art, in some embodiments, each rod of quadrupole rods 130a, 130b of the quadrupole rod set can be coupled to an RF power supply such that the rods on opposed sides of the central axis together form a rod pair to which a substantially identical RF signal is applied. That is, the rod pair 130a can be coupled to a first RF power supply that provides a first RF voltage to the first pair of rods 130a at a first frequency and in a first phase. On the other hand, the rod pair 130b can be coupled to a second RF power supply that provides a second RF voltage at a second frequency (which can be the same as the first frequency), but opposite in phase to the RF signal applied to the first pair of rods 130a. As will be appreciated by a person skilled in the art, a DC offset voltage can also be applied to the rods 130a, 130b of the quadrupole rod set.

As shown in FIG. 2, the multipole ion guide 120 additionally can include a plurality of auxiliary electrodes 140 interposed between quadrupole rods 130a, 130b of the quadrupole rod set that also extend along the central axis. As shown in FIG. 2, each auxiliary electrode 140 can be separated from another auxiliary electrode 140 by a rod 130a, 130b of a quadrupole rod set. Further, each of the auxiliary electrodes 140 can be disposed adjacent to and between a rod 130a of the first pair and a rod 130b of the second pair. As will be discussed in detail below, each of the auxiliary electrodes 140 can be coupled to an RF and/or DC power supply (e.g., power supplies 105 and 107 of FIG. 1) for providing an auxiliary electrical signal to the auxiliary electrodes 140 so as to control or manipulate the transmission of ions from the multipole ion guide 120 as otherwise described herein. By way of non-limiting example, in one embodiment, a DC voltage equal to the DC offset voltage applied to quadrupole rods 130a, 130b of the quadrupole rod set can be applied to the auxiliary electrodes 140. It should be appreciated that such an equivalent DC voltage applied to the auxiliary electrodes 140 would have substantially no effect on the radial forces experienced by the ions in the multipole ion guide 120 such that the multipole ion guide would function as a conventional collimating quadrupole ion guide. Alternatively, in accordance with various aspects of the present teachings, while quadrupole rods 130a, 130b of the quadrupole rod set are maintained at a DC offset voltage with a first RF voltage applied to the first pair of rods 130a at a first frequency and in a first phase and a second RF voltage (e.g., of the same amplitude (V₀₋ₚ)) as the first RF voltage) at a second frequency but opposite in phase applied to the second pair of rods 130b, a variety of auxiliary electrical signals can be applied to the auxiliary electrodes 140, including i) a DC voltage different than the DC offset voltage, but without an RF component; ii) an RF signal at a third amplitude and frequency (e.g., different than the first frequency) and in a third phase, while the DC voltage is equivalent to the DC offset voltage; and iii) both a DC voltage different than the DC offset voltage and an RF signal at a third amplitude and frequency and in a third phase, all by way of non-limiting example. Moreover, it will be appreciated that the auxiliary RF and/or DC signals applied to the auxiliary electrodes 140 in accordance with various aspects of the present teachings can be combined with other techniques known in the art utilized to increase the radial amplitudes of ions in a conventional collimating quadrupole ion guide. Such exemplary techniques include a dipolar DC application, quadrupolar DC application, and resonance excitation using a supplementary AC signal applied to the rods of the quadrupole, the AC signal being resonant or nearly resonant with some of the ions in the ion beam, all by way of non-limiting example.

It will be appreciated in light of the present teachings that the auxiliary electrodes 140 can have a variety of configurations. By way of example, the auxiliary electrodes 140 can have a variety of shapes (e.g., round, T-shaped), though T-shaped electrodes can be preferred as the extension of the stem 160 toward the central axis of the multipole ion guide 120 from the base 150 allows the innermost conductive surface of the auxiliary electrode to be disposed closer to the central axis (e.g., to increase the strength of the field within the multipole ion guide 120). In various aspects, the T-shaped electrodes can have a substantially constant cross section along their length such that the innermost radial surface of the stem 160 remains at a substantially constant distance from a central axis along the entire length of the auxiliary electrodes 140. Round auxiliary electrodes (or rods of other cross-sectional shapes) can also be used in accordance with various aspects of the present teachings, but would generally exhibit a smaller cross-sectional area relative to the quadrupole rods 130a, 130b due to the limited space between the quadrupole rods 130a, 130b and/or require the application of larger auxiliary potentials due to their increased distance from a central axis.

As noted above, the auxiliary electrodes 140 need not extend along the entire length of the quadrupole rods 130a, 130b. For example, in some embodiments, the auxiliary electrodes 140 can have a length less than half of the length of quadrupole rods 130a, 130b of the quadrupole rod set (e.g., less than 33%, less than 10%). Whereas the rod electrodes of a conventional Q0 quadrupole can have a length along the longitudinal axis in a range from about 10 cm to about 30 cm, the auxiliary electrodes 140 can have a length of 10 mm, 25mm, or 50 mm, all by way of non-limiting example. Moreover, though FIG. 1 depicts the auxiliary electrodes 140 disposed about halfway between the proximal and distal ends of quadrupole rods 130a, 130b of the quadrupole rod set, auxiliary electrodes 140 can be positioned more proximal or more distal relative to this depicted exemplary embodiment. By way of example, the auxiliary electrodes 140 can be disposed at any of a proximal third, middle third, or distal third of a quadrupole rod set. Indeed, because of the relatively shorter length of auxiliary electrodes 140, it will be appreciated that quadrupole rods 130a, 130b of the quadrupole rod set can accommodate multiple sets of auxiliary electrodes 140 at various positions along a central axis. By way of example, it is within the scope of the present teachings that the mass spectrometry system 100 can include a first, proximal set of auxiliary electrodes to which a first auxiliary electrical signal can be applied (e.g., a DC voltage different from the DC offset voltage of rods 130a, 130b) and one or more distal sets of auxiliary electrodes to which a second auxiliary electrical signal can be applied (e.g., having an RF component).

With reference now to FIG. 3, a portion of an exemplary prototype of a multipole ion guide 120 according to an embodiment is depicted. As shown in FIG. 3, the multipole ion guide 120 can include four T-shaped electrodes 140 having a base portion 150 and a stem portion 160 extending therefrom. The electrodes 140, which are 10 mm in length and have a stem 160 approximately 6 mm in length, can be coupled to a mounting ring 142 that can be mounted to a desired location of a quadrupole rod set, in accordance with various aspects of the present teachings. By way of non-limiting example, the exemplary mounting ring 142 can include notches for securely engaging quadrupole rods 130a, 130b of the quadrupole rod set (e.g., as with quadrupole 130a, shown in phantom). As shown, a single lead 144, which can be coupled to an RF power supply 105 and/or DC power supply 107, can also be electrically coupled to each of the auxiliary electrodes 140 such that a substantially identical auxiliary electrical signal is applied to each of the auxiliary electrodes 140.

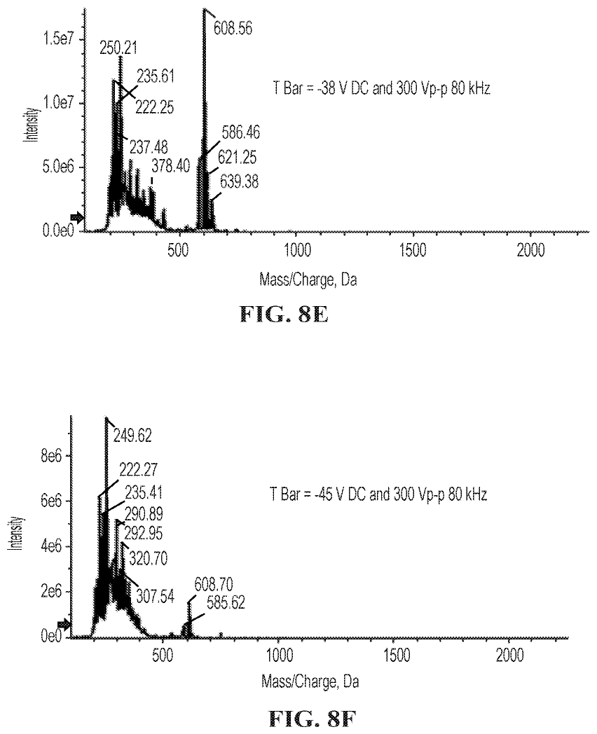

With reference now to FIG. 9, another exemplary multipole ion guide 120 of FIG. 1 is depicted in more detail. In particular, a portion of an exemplary multipole ion guide 120 is depicted. As shown in FIG. 9, a multipole ion guide 120 is depicted in cross-sectional schematic view across a location of auxiliary electrodes 140 depicted in FIG. 1. As shown in more detail in FIG. 1 and as explained above, a multipole ion guide 120 generally can include a set of four rods 130a, 130b that extend from a proximal, inlet end disposed adjacent the inlet orifice 112a to a distal, outlet end disposed adjacent the exit aperture 112b. The rods 130a, 130b surround and extend along a central axis of the multipole ion guide 120, thereby defining a space through which the ions are transmitted.

Multipole ion guide 120 can further include a plurality of auxiliary electrodes 140 interposed between quadrupole rods 130a, 130b of the quadrupole rod set that also extend along a central axis (shown in phantom). Each auxiliary electrode 140 can be separated from another auxiliary electrode 140 by a rod of quadrupole rods 130a, 130b of the quadrupole rod set. Further, each of the auxiliary electrodes 140 can be disposed adjacent to and between a rod 130a of the first pair and a rod 130b of the second pair.

Each of the auxiliary electrodes 140 can be coupled to an RF and/or DC power supply (e.g., power supplies 105 and 107 of FIG. 1) for providing an auxiliary electrical signal to auxiliary electrodes 140 so as to control or manipulate a transmission of ions from a multipole ion guide 120 as otherwise described herein.

By way of non-limiting example, in accordance with various aspects of the present teachings, while quadrupole rods 130a, 130b of the quadrupole rod set are maintained at a DC offset voltage with a first RF voltage applied to the first pair of rods 130a at a first frequency and in a first phase and a second RF voltage (e.g., of a same amplitude (V₀₋ₚ) as the first RF voltage) at a second frequency but opposite in phase applied to the second pair of rods 130b, a variety of auxiliary electrical signals can be applied to the auxiliary electrodes 140. As shown in FIG. 9, each auxiliary electrode 140 has a DC voltage of the same amplitude 910 applied thereto. In particular, the schematic cross section view of FIG. 9 shows the T-shaped RF/DC filter electrodes and the round multipole ion guide electrodes. All the T-shaped electrodes of the RF/DC filter are biased at the same DC voltage.

As explained above, for example, each auxiliary electrode 140 has a DC voltage of the same amplitude and phase applied thereto, which is different than the DC offset voltage that is applied to the rods of the quadrupole rod set. That is, a mass windowing device for a multipole ion guides is created. A DC voltage in this embodiment can be either attractive or repulsive relative to a DC offset voltage applied to the rods of the quadrupole rod set of the multipole ion guide. For example, in such an embodiment, the difference in the applied auxiliary DC voltage and the DC offset voltage would result in generating a high m/z cutoff of the ions transmitted and removal of such ions that can contaminate downstream ion optics.

Ion guides disclosed herein are generally operated at neutral gas pressures of about 2 to 20e−3 Torr and have radial confining RF frequencies of about 1 MHz and voltages of about 50 to 1000 V₀₋ₚₑₐₖ.

In some aspects, the present disclosure encompasses a recognition that generation of a m/z cutoff as above disclosed may result in slower or reduced ion transmission. In some embodiments, for example, when an environment of an elevated pressure exists in an ion guide, ions will suffer numerous collisions. In some embodiments, in absence of an applied axial field, transmission of ions will slow. In some embodiments, transmission will virtually (substantially) halt. By contrast, under conditions of normal operation of an API mass spectrometry system, there generally exists a sufficient number of incoming ions to drive, push, or transmit these slowing ions along to an exit orifice of a multipole ion guide. That is, a space charge-induced push is naturally created. A magnitude of such a space charge-induced push will depend on a number density of incoming ions.

In some embodiments, as above disclosed, a radial profile of the DC fields from the RF/DC filter provides either a small potential well or a barrier along an axis of a multipole ion guide that is dependent on the applied DC voltages. In some embodiments, when coupled with very low local ion velocities, a small potential well or a barrier along an axis of a multipole ion guide can lead to a time lag in transit time through an RF/DC filter.

In some embodiments, a result of a small potential well or potential barrier along an axis of a multipole ion guide can result in an unstable ion signal and/or changes in DC voltages that give rise to a high m/z cutoff.

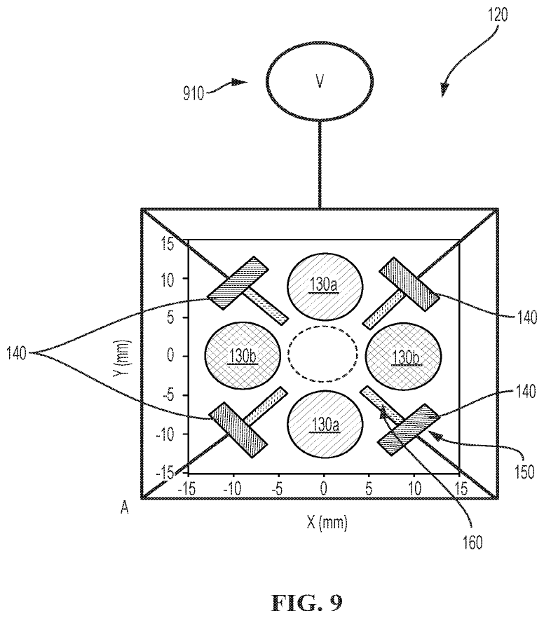

FIG. 10 for example shows an effect of a small potential well. In particular, FIG. 10 is a schematic of an attractive potential well that arises when the rods of the quadrupole rod set are interspersed with auxiliary electrodes to generate an RF/DC filter that is attractively biased. An attractive DC voltage applied to an RF/DC filter as disclosed herein can give rise to a potential well within a multipole ion guide in which incoming ions can be trapped. In such a configuration, ions will continue to be trapped until the well is “filled up” by additional ions generated. During this time and until the well is filled up, fewer ions will be exiting the multipole ion guide than expected. In some embodiments, such an arrangement could lead to poor ion signal stability.

In some embodiments, an ion signal instability problem can depend on an ion flux. In particular, a key factor in ion passage beyond the RF/DC filter and toward a mass analyzer is how quickly the potential well can be filled in from the incoming ions. In some aspects, for example, analytical samples having a lower ion concentration will require more time to fill up the potential well and will display more ion signal instability than analytical samples that have a high ion concentration.

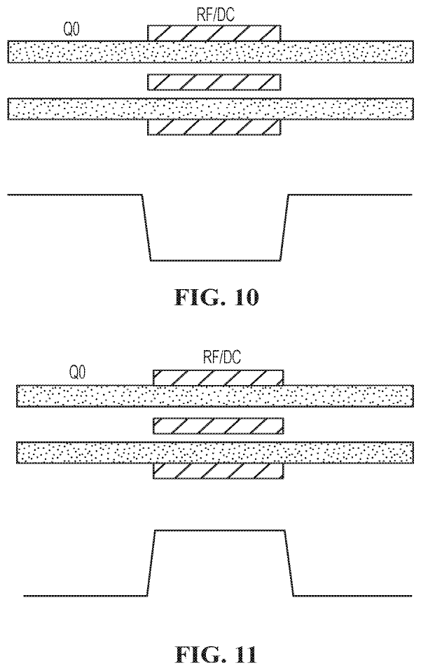

FIG. 11 for example shows an effect of a barrier along an axis of a multipole ion guide. In particular, FIG. 11 is a schematic of a repulsive axial barrier that arises when the rods of the quadrupole rod set are interspersed with auxiliary electrodes to generate an RF/DC filter that is repulsively biased. In some embodiments, for example as shown in FIG. 11, when a DC voltage is applied to an RF/DC filter that is repulsive relative to a DC offset of a multipole ion guide, a potential barrier will be created.

In some embodiments, a potential barrier will delay ion passage beyond an RF/DC filter until a sufficient number of ions have built up to overcome such a barrier. In some embodiments, such an arrangement could lead to a loss of signal stability with time.

In some embodiments, a result of either a small potential well or a barrier along an axis of a multipole ion guide, for example as shown in FIG. 10 and FIG. 11, could be for example an unstable ion signal and/or changes in DC voltages that give rise to a high m/z cutoff.

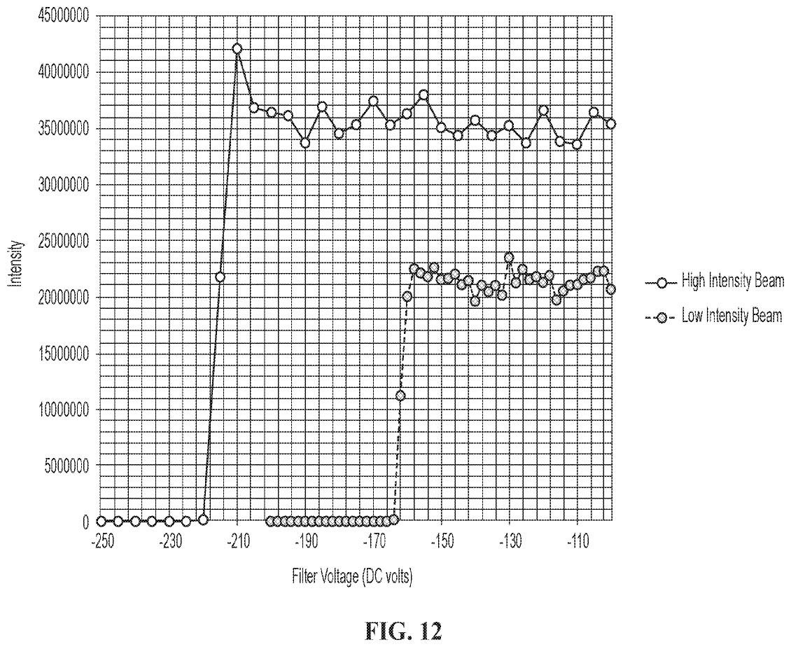

Changes in DC voltage required to give rise to a given high m/z cutoff are demonstrated in FIG. 12. Two extracted ion chromatogram profiles are shown in FIG. 12, which display ion signals of m/z 564. RF/DC filter electrodes are all biased the same for the resultant ion chromatogram profiles shown in FIG. 12. The multipole ion guide was at 940 kHz and a fixed voltage of about 350 V₀₋ₚₑₐₖ. A Filter Voltage (DC volts), which is an auxiliary voltage, is reduced to −250 volts relative to a DC offset voltage for the quadrupole rods of a multipole ion guide.

Data shows an exemplary extracted ion chromatogram profile for a high intensity ion beam and a low intensity ion beam. Both high and low intensity ion chromatogram profiles were obtained using 10-mm long T-shaped auxiliary electrodes for the RF/DC filter. One profile shows an ion signal of m/z 564 having a high intensity ion beam. A second profile shows an ion signal of m/z 564 having a low intensity ion beam. Referring to the low intensity ion beam of FIG. 12, a cutoff of ion signal occurs at about −165V. Referring to the high intensity ion beam of FIG. 12, a cutoff of ion signal occurs at about −220V.

Without wishing to be bound to a specific theory, it is believed that this difference, that is the difference in cutoff voltage for low and high intensity ion beams, in the example of FIG. 12, an approximately 55V difference, is due to different ion interaction times with the auxiliary electrodes in a presence of a potential well formed by an attractive filter electrodes.

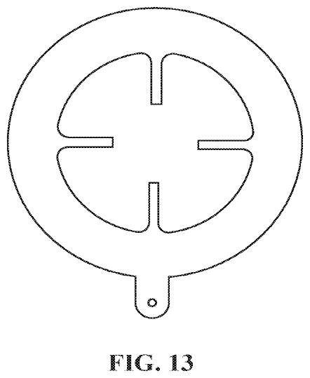

In some embodiments, an unstable ion signal and/or changes in DC voltages that give rise to a high m/z cutoff that are a result of either a small potential well or a barrier along an axis of a multipole ion guide may be reduced by using very short electrodes. FIG. 13 shows an auxiliary electrode assembly having a set of electrodes with 13-mm long stems interposed between rods of a quadruple of a multipole ion guide. In some embodiments, an assembly is about 0.5-mm thick.

While not wishing to be bound to a particular theory, an electrode assembly as shown in FIG. 13 minimizes a width of a potential well generated along the axis of a multipole ion guide. In some embodiments, for example, an attractive potential well arises when auxiliary electrodes of an auxiliary electrode assembly are attractively biased and/or minimizes a repulsive axial barrier when auxiliary electrodes of an auxiliary electrode assembly are repulsively biased. The result is a reduction of effects of changing ion currents on voltage required for a specific high m/z cutoff.

As above explained, in some embodiments, either a small potential well or a barrier along an axis of a multipole ion guide could result in an unstable ion signal and/or changes in DC voltages that give rise to a high m/z cutoff. In some embodiments, for example, an attractive potential well arises when auxiliary electrodes of an auxiliary electrode assembly are attractively biased and a repulsive axial barrier is lowered (i.e. minimized) when auxiliary electrodes of an auxiliary electrode assembly are repulsively biased. The result is a reduction of effects of changing ion currents on voltage required for a specific high m/z cutoff. As noted, it is believed that an unstable ion signal and/or different DC voltages that give rise to a high m/z cutoff can be due to different ion interaction times with the auxiliary electrodes in the presence of a potential well formed by an attractive filter electrodes.

While not wishing to be bound to a particular theory, such issues of ion signal instability and varying high mass cutoff values can be overcome by using alternate biasing arrangements of auxiliary electrodes of an auxiliary electrode assembly, that is by biasing RF/DC filter electrodes in a manner to minimize the potential well or barrier formation.

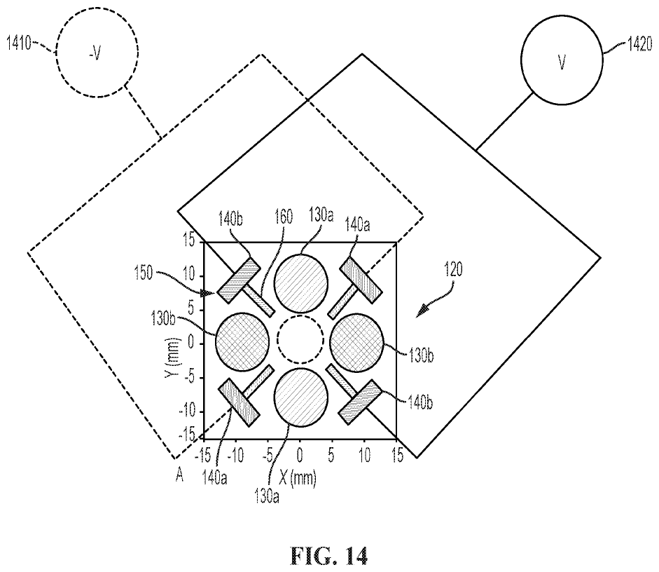

Referring to FIG. 14, an exemplary multipole ion guide 120 is depicted in a cross-sectional schematic view of a location of auxiliary electrodes 140a, 140b (collectively 140 of FIG. 1). As noted above, in some embodiments, a multipole ion guide 120 can include a set of four rods 130a, 130b that extend from a proximal, inlet end disposed adjacent to an inlet orifice 112a of FIG. 1 to a distal, outlet end disposed adjacent to an exit aperture 112b of FIG. 1. Rods 130a, 130b surround and extend along a central axis (shown in phantom) of a multipole ion guide 120, thereby defining a space through which ions are transmitted.

Similar to previous embodiments, in this embodiment, the multipole ion guide 120 as provided herein can further include a plurality of auxiliary electrodes, auxiliary electrodes 140a, 140b which extend from a proximal, inlet end disposed adjacent to an inlet orifice 112a of FIG. 1 to a distal, outlet end disposed adjacent to an exit aperture 112b of FIG. 1. In some embodiments, auxiliary electrodes 140a, 140b partially extend from a proximal, inlet end disposed adjacent to an inlet orifice 112a of FIG. 1 to a distal, outlet end disposed adjacent to an exit aperture 112b of FIG. 1. In some embodiments, auxiliary electrodes 140a, 140b fully extend from a proximal, inlet end disposed adjacent to an inlet orifice 112a of FIG. 1 to a distal, outlet end disposed adjacent to an exit aperture 112b of FIG. 1.

The auxiliary electrodes 140a, 140b can have a variety of configurations. By way of example, the auxiliary electrodes 140a, 140b can have a variety of shapes (e.g., round, T-shaped), though T-shaped electrodes can be preferred as the extension of the stem 160 toward a central axis of the multipole ion guide 120 from the base 150 allows the innermost conductive surface of the auxiliary electrode to be disposed closer to a central axis (e.g., to increase the strength of the field within the multipole ion guide 120).

In some embodiments, auxiliary electrodes 140a, 140b disclosed herein are characterized both by their position relative to one another and to quadrupole rods 130a, 130b of the quadrupole rod set, and/or by a voltage applied thereto.

In some embodiments, auxiliary electrodes 140a, 140b are radially positioned around a central axis. In some embodiments, auxiliary electrodes 140a, 140b are interposed between quadrupole rods 130a, 130b of the quadrupole rod set. In some embodiments, auxiliary electrodes 140a, 140b are uniformly spaced among and interposed between quadrupole rods 130a, 130b of the quadrupole rod set.

In this embodiment, each auxiliary electrode 140a is radially opposite from another auxiliary electrode 140a and each auxiliary electrode 140b is radially opposite from another auxiliary electrode 140b. That is, in this embodiment, each auxiliary electrode 140a is radially separated from another auxiliary electrode 140a by a single quadrupole rod 130a, a single quadrupole rod 130b, and a single auxiliary electrode 140b. Stated another way, in this embodiment, each auxiliary electrode 140a is separated from another auxiliary electrode 140a relative to a central axis in a clockwise (and a counterclockwise) direction by quadrupole rods 130a and 130b, and a single auxiliary electrode 140b.

Each auxiliary electrode 140a is shown radially opposite from another auxiliary electrode 140a and each auxiliary electrode 140b is shown radially opposite from another auxiliary electrode 140b in FIG. 14.

As above mentioned, each auxiliary electrode 140a, 140b can be coupled to an RF and/or DC power supply (e.g., power supplies 105 and 107 of FIG. 1) for providing an auxiliary electrical signal to auxiliary electrodes 140a, 140b so as to control or manipulate transmission of ions from a multipole ion guide 120 as otherwise described herein.

FIG. 14 shows a configuration using an alternate biasing arrangement of auxiliary electrodes of an auxiliary electrode assembly. In this embodiment, a first pair of auxiliary electrodes, e.g. 140a, are biased positively and a second pair of auxiliary electrodes, e.g. 140b, are biased negatively. In such biasing of auxiliary electrodes can minimize a potential well or barrier formation thereby reducing both ion signal instability and variation of high mass cutoff values. In this embodiment, auxiliary electrodes 140a can be physically separate or at least electrically isolated from auxiliary electrodes 140b. Auxiliary electrodes can be coupled to a different DC voltage source or the same DC voltage source (i.e. one source configured to provide more than one voltage signal).

In this embodiment, auxiliary electrodes 140a, 140b are biased with a DC voltage. In some embodiments, auxiliary electrodes 140a, 140b are biased with a DC voltage having a same amplitude. In some embodiments, a pair of auxiliary electrodes 140a is biased with DC voltage having a same amplitude as another pair of auxiliary electrodes 140b but where a DC voltage to each pair, 140a, 140b is opposite in sign. That is, in some embodiments, each pair of auxiliary electrodes 140a, 140b is biased with a same voltage but with an opposing sign. For example, auxiliary electrode 140a can have a negative (−) charge and auxiliary electrode 140b can have a positive (+) charge. In this embodiment, the auxiliary electrodes 140a, 140b are biased with DC voltages that have substantially the same amplitude but opposite phases.

For example, a voltage 1410 supplied to the pair of auxiliary electrodes 140a is negative and a voltage 1420 supplied to a pair of auxiliary electrodes 140a is positive.

In some embodiments, a biasing scheme such as depicted in FIG. 14 can virtually removes any potential wells and barriers that can lead to above described ion signal instability and variations of high mass cutoff values.

In some embodiments, such an arrangement can include a supplied voltage 1410 and 1420 of the same amplitude. In some embodiments, a supplied voltage 1410 and 1420 is of the same amplitude and of a different voltage relative to a DC offset voltage of the RF ion guide. In some embodiments, a voltage 1410 supplied to a pair of auxiliary electrodes 140a may be negative or positive. In some embodiments, a voltage 1420 supplied to a pair of auxiliary electrodes 140b may be negative or positive.

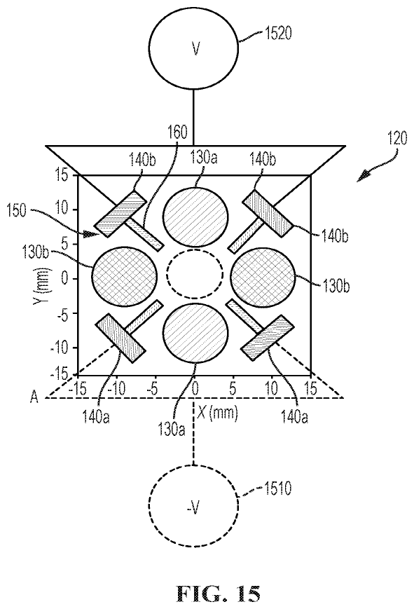

Referring to FIG. 15, an exemplary multipole ion guide 120 is depicted in a cross-sectional schematic view, which shows the location of auxiliary electrodes 140a, 140b. As noted above, in some embodiments, a multipole ion guide 120 can include a set of four rods 130a, 130b that extend from a proximal, inlet end disposed adjacent to an inlet orifice 112a of FIG. 1 to a distal, outlet end disposed adjacent to an exit aperture 112b of FIG. 1. Quadrupole rods 130a, 130b surround and extend along a central axis (shown in phantom) of a multipole ion guide 120, thereby defining a space through which ions are transmitted.

The multipole ion guide 120 as provided herein can further include a plurality of auxiliary electrodes 140a, 140b, which extend from a proximal, inlet end disposed adjacent to an inlet orifice 112a of FIG. 1 to a distal, outlet end disposed adjacent to an exit aperture 112b of FIG. 1. In some embodiments, auxiliary electrodes 140a, 140b partially extend from a proximal, inlet end disposed adjacent to an inlet orifice 112a of FIG. 1 to a distal, outlet end disposed adjacent to an exit aperture 112b of FIG. 1. In some embodiments, auxiliary electrodes 140a, 140b fully extend from a proximal, inlet end disposed adjacent to an inlet orifice 112a of FIG. 1 to a distal, outlet end disposed adjacent to an exit aperture 112b of FIG. 1.

In some embodiments, as above addressed, auxiliary electrodes 140a, 140b can have a variety of configurations. By way of example, the auxiliary electrodes 140a, 140b can have a variety of shapes (e.g., round, T-shaped), though T-shaped electrodes can be preferred as the extension of the stem 160 toward a central axis of the multipole ion guide 120 from the base 150 allows the innermost conductive surface of the auxiliary electrode to be disposed closer to a central axis (e.g., to increase the strength of the field within the multipole ion guide 120).

In some embodiments, auxiliary electrodes 140a, 140b disclosed herein are characterized both by their position relative to one another and to quadrupole rods 130a, 130b of the quadrupole rod set, and/or by a voltage applied thereto.

In some embodiments, auxiliary electrodes 140a, 140b are radially positioned around a central axis. The auxiliary electrodes 140a, 140b are interposed between quadrupole rods 130a, 130b of the quadrupole rod set. In this embodiment, the auxiliary electrodes 140a, 140b are uniformly spaced among and interposed between quadrupole rods 130a, 130b of the quadrupole rod set.

As above mentioned, in some embodiments, each auxiliary electrode 140a, 140b can be coupled to an RF and/or DC power supply (e.g., power supplies 105 and 107 of FIG. 1) for providing an auxiliary electrical signal to auxiliary electrodes 140a, 140b so as to control or manipulate transmission of ions from a multipole ion guide 120 as otherwise described herein.

FIG. 15 shows a configuration using an alternate biasing arrangement of auxiliary electrodes of an auxiliary electrode assembly. In some embodiments, such alternate biased auxiliary electrodes 140a, 140b may minimize the formation of a potential well or barrier formation thereby reducing both ion signal instability and variation of high mass cutoff values. In this embodiment, auxiliary electrodes 140a can be physically separate or at least electrically isolated from auxiliary electrodes 140b. Auxiliary electrodes can be coupled to a different DC voltage source (i.e. another separate source) or the same DC voltage source (i.e. one source configured to provide more than one voltage signal).

In some embodiments, auxiliary electrodes 140a, 140b are biased with a DC voltage. In some embodiments, auxiliary electrodes 140a, 140b are biased with a DC voltage having a same amplitude. In some embodiments, a pair of auxiliary electrodes 140a is biased with DC voltage having a same amplitude as another pair of auxiliary electrodes 140b but where a DC voltage to each pair 140a, 140b is opposite in sign. That is, in some embodiments, each pair of auxiliary electrodes 140a, 140b is biased with a same voltage but with an opposing sign. For example, auxiliary electrode 140a can have a negative (−) charge and auxiliary electrode 140b can have a positive (+) charge. In this embodiment, the auxiliary electrodes 140a, 140b are biased with DC voltages that have substantially the same amplitude but opposite phases.

For example, a voltage 1510 supplied to the pair of auxiliary electrodes 140a is negative and a voltage 1520 supplied to a pair of auxiliary electrodes 140a is positive. In some embodiments, a biasing scheme such as that depicted in FIG. 15 can virtually remove any potential wells and barriers that could otherwise lead to above described ion signal instability and variations of high mass cutoff values.

In some embodiments, such an arrangement can include a supplied voltage 1510 and 1520 of a same amplitude. In some embodiments, the voltages 1510 and 1520 applied to the auxiliary electrodes can have the same value but are different relative to a DC offset voltage applied to an RF ion guide. In some embodiments, a voltage 1510 supplied to a pair of auxiliary electrodes 140a may be negative or positive. In some embodiments, a voltage 1520 supplied to a pair of auxiliary electrodes 140b is may be negative or positive.

In some embodiments, a biasing scheme such as depicted in FIG. 15 virtually removes any potential wells and barriers that can lead to above described ion signal instability and variations of high mass cutoff values.

### Exemplification

The following examples illustrate some embodiments and aspects of the present disclosure. It will be apparent to those skilled in the relevant art that various modifications, additions, substitutions, and the like can be performed without altering the spirit or scope of the disclosure, and such modifications and variations are encompassed within the scope of the disclosure as defined in the claims, which follow. The present disclosure will be more fully understood by reference to these examples. The following examples do not in any way limit the present disclosure or the claimed disclosures and they should not be construed as limiting the scope.

As noted above, a variety of RF and/or DC signals can be applied to the auxiliary electrodes 140 so as to control or manipulate the transmission of ions from the multipole ion guide 120 into the downstream vacuum chamber 114 in accordance with the present teachings. The above teachings will now be demonstrated using the following examples, provided to demonstrate but not limit the present teachings, in which i) a DC voltage (without an RF component) different than the DC offset voltage applied to the rods 130a, 130b is applied to the exemplary auxiliary T-shaped electrodes 140 of FIG. 2; ii) an RF signal is applied to the exemplary auxiliary T-shaped electrodes 140 of FIG. 2 (the DC voltage applied to electrodes 140 is equivalent to the DC offset voltage); and iii) both a DC voltage different than the DC offset voltage applied to the rods 130a, 130b and an RF signal are applied to the exemplary auxiliary T-shaped electrodes 140 of FIG. 2.

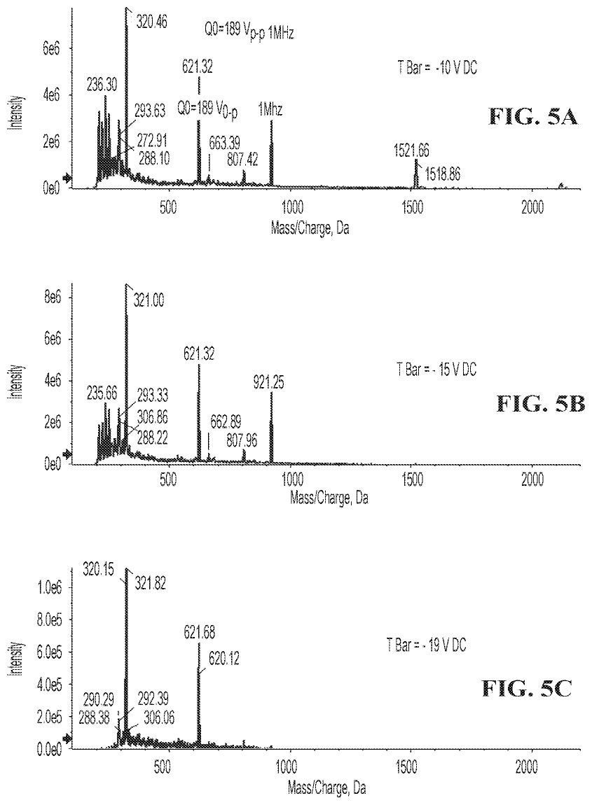

With reference first to FIGS. 4A-C, exemplary data is depicted demonstrating the transmission of various ions through a 4000 QTRAP® System (marketed by SCIEX) modified in accordance with the present teachings to include auxiliary T-shaped electrodes 140 having a length of about 50 mm located about 12 cm downstream from the proximal, inlet end of the quadrupole rods of Q0 (which have a length of about 18 cm). The quadrupole rods of Q0 were maintained at a −10V DC offset, with various RF signals of different amplitudes (i.e., 189 V₀₋ₚ, 283 V₀₋ₚ, 378 V₀₋ₚ, and 567 V₀₋ₚ) being applied to the quadrupole rods. The frequency of the main drive RF applied to the quadrupole rods was approximately 1 MHz, with the signals applied to adjacent quadrupole rods being opposite in phase to one another.

FIGS. 4A-C depict the change in transmission of ions exhibiting a m/z of 322 Da, 622 Da, and 922 Da, respectively, through the multipole ion guide as the DC voltage applied to the auxiliary electrodes is adjusted away from the DC offset voltage (i.e., −10V DC). For example, with specific reference now to FIG. 4A, transmission of ions having a m/z of 322 Da is substantially stopped at an auxiliary DC voltage of about ±10-15V DC from the DC offset voltage (i.e., at about −18-22V DC and +12-15V DC) for each of the various RF signals applied to the quadrupole rods. As shown in FIGS. 4B and 4C, however, the DC cutoff for ions of increased m/z varies substantially depending on the amplitude of the RF applied to the quadrupole rods (generally, as V₀₋ₚ increases, increasingly higher auxiliary DC voltages are required to stop transmission of ions through the multipole ion guide). By way of example, for ions having a m/z of 922 Da, the cutoff is approximately at ±10V DC from the DC offset voltage (i.e., at −20V DC and 0V DC) at 189 V₀₋ₚ, while at 567 V₀₋ₚ the cutoff is approximately ±25V DC from the DC offset voltage (i.e., at −35V DC and +15V DC). In light of these examples, it will be appreciated that the RF voltages applied to the quadrupole rod sets and/or the auxiliary DC signal can be adjusted (e.g., via controller 103) so as to substantially prohibit transmission of all ions to the downstream mass analyzers. By way of non-limiting example, the auxiliary DC voltages can be adjusted away from the DC offset voltage beyond the cutoff point of substantially all ions generated by the ion source. The above data also indicates that the amplitude of the RF signal applied to the quadrupole rods can be decreased separately, or simultaneously in conjunction with the increase of the difference between the auxiliary DC voltage and the DC offset voltage, so as to prevent transmission of ions through the multipole ion guide. Accordingly, methods and systems in accordance with the present teachings can stop the flow of ions into the downstream mass analyzers (e.g., further reducing contamination), for example, during periods of times when it is known that analytes are not present in a sample being delivered to a continuous ion source (e.g. at early or late parts of the gradient elution of a liquid chromatograph) and/or when a downstream mass analyzer (e.g., an ion trapping device) is processing ions previously transmitted through the multipole ion guide.

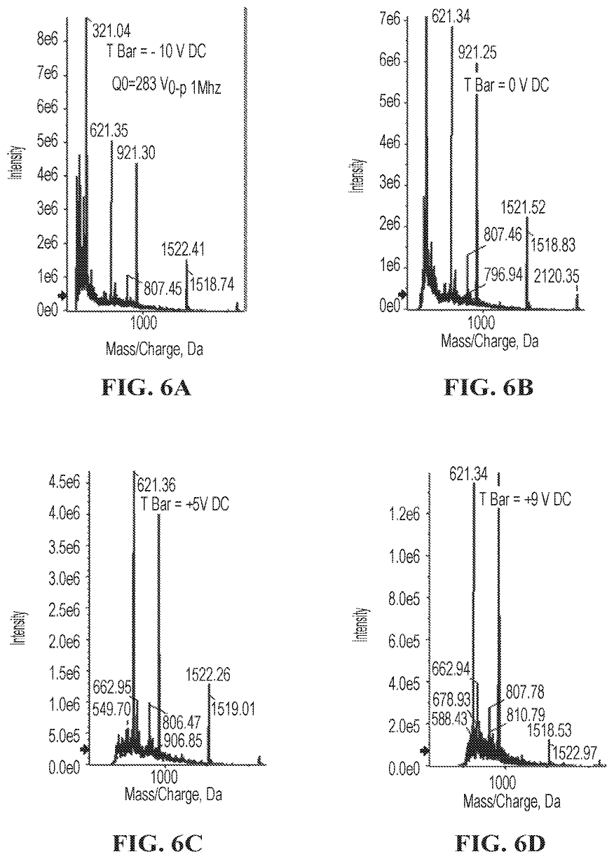

With continued reference to FIGS. 4A-C, it should be appreciated that at an auxiliary DC voltage of about −10V DC, the electric field within the multipole ion guide would not be substantially altered by the auxiliary DC voltage such that the multipole ion guide would function as a conventional collimating quadrupole (i.e., as if the auxiliary electrodes were not even present). Though methods and systems in accordance with various aspects of the present teachings can be effective to reduce the transmission of unwanted ions (e.g., interfering/contaminating ions of high m/z as discussed otherwise herein and with specific respect to FIGS. 5A-C below), FIGS. 4A-C surprisingly demonstrate that the overall ion transmission through the multipole ion guide can be increased relative to a conventional collimating quadrupole as the auxiliary DC signal is adjusted away from the DC offset voltage. That is, as shown in FIGS. 4A-C, the overall detected ion current is initially increased by the auxiliary DC voltages relative to the ion current generated when the auxiliary DC voltage is maintained at the DC offset voltage. Without being bound by any particular theory, it is believed that this increase in ion current can be attributed to the increased de-clustering of ions within the multipole ion guide caused by the auxiliary DC signal. Whereas these heavy, charged clusters may be neutralized in a conventional collimating quadrupole Q0 and/or contaminate downstream optical elements and mass analyzers following transmission through Q0 into a downstream vacuum chamber, methods and systems in accordance with various aspects of the present teachings can surprisingly be used to de-cluster these charged clusters within the multipole ion guide, thereby liberating ions therefrom and potentially increasing sensitivity by allowing for transmission/detection of the ions of interest that are typically lost in conventional systems.

With reference now to FIGS. 5A-C, exemplary mass spectra are depicted following transmission of an ionized standard (Agilent ESI Tuning Mix, G2421, Agilent Technologies) through a 4000 QTRAP® System modified in accordance with various aspects of the present teachings to include auxiliary T-shaped electrodes having a length of about 50 mm located about 12 cm downstream from the proximal, inlet end of the quadrupole rods of Q0 (which have a length of about 18 cm). The quadrupole rods of Q0 were maintained at a −10V DC offset, with an RF signal of 189 V₀₋ₚ being applied to the quadrupole rods. The frequency of the main drive RF applied to the quadrupole rods was approximately 1 MHz, with the signals applied to adjacent quadrupole rods being opposite in phase to one another.

To generate the mass spectrogram of FIG. 5A, the auxiliary electrodes were maintained at −10V DC (i.e., at the same DC offset voltage of quadrupole rods) such that the multipole ion guide substantially functioned as a conventional collimating quadrupole. For FIG. 5B, the auxiliary DC voltage was adjusted away from the DC offset voltage by decreasing the voltage of the auxiliary rods to −15V DC (ΔV=−5V DC relative to DC offset). That is, compared to the quadrupole rods, the auxiliary electrodes were 5V more attractive to the positive ions generated by the ion source. To obtain the spectrogram of FIG. 5C, the auxiliary DC voltage was further decreased to −19V DC (ΔV=−9V DC). No RF signal was applied to the auxiliary electrodes.

Comparing FIG. 5B to FIG. 5A, it can be observed that by adjusting (in this case decreasing, making the auxiliary electrodes more attractive to positive ions) the auxiliary DC voltage relative to the DC offset voltage, that the configuration of FIG. 5B was effective to filter high m/z ions. For example, while identifiable peaks are present in FIG. 5A at 1518.86 Da and 1521.66 Da, these peaks are absent from FIG. 5B. Indeed, there is no discernible signal in FIG. 5B at m/z greater than about 1400 Da.

In comparing FIG. 5C to FIG. 5B, it is observed that by further decreasing the auxiliary DC voltage relative to the DC offset voltage, the high m/z ions are further filtered. For example, while an identifiable peak is present in FIG. 5B at 921.25 Da, this peak is absent in FIG. 5C. Indeed, there is no discernible signal in FIG. 5C beyond about 900 Da. It should also be noted that increased filtering of low m/z ions can also be observed in comparing FIG. 5C to FIG. 5B, though this effect is less pronounced than the high-pass filter effect. For example, an identifiable peak present in FIG. 5B at 235.66 Da is absent in FIG. 5C. It will thus be appreciated that ion guides in accordance with various aspects of the present teachings can be operated as a low-pass filter (as in FIG. 5B) and/or as a bandpass filter (as in FIG. 5C) by adjusting the auxiliary DC signal, thereby potentially preventing interfering/contaminating ions from being transmitted to downstream mass analyzers.

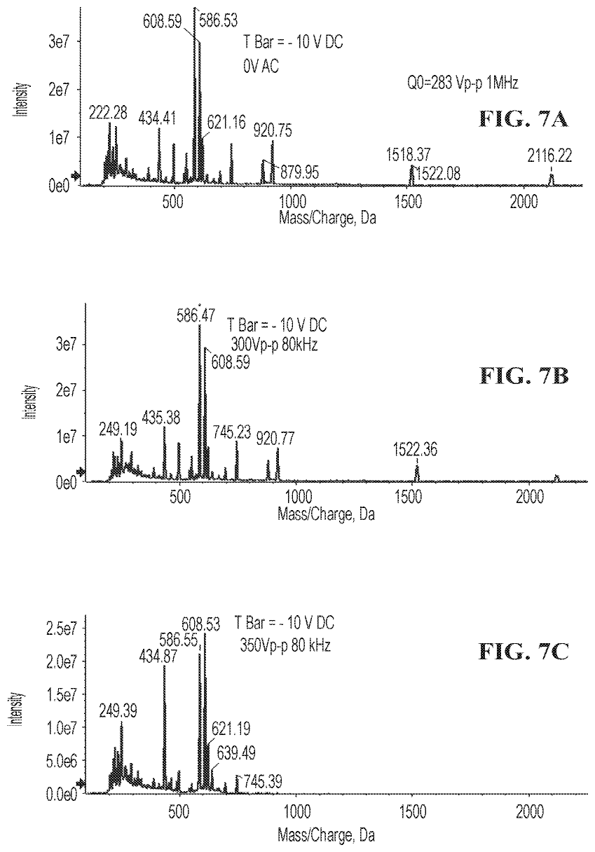

With reference now to FIGS. 6A-D, exemplary mass spectra are depicted following transmission of an ionized standard (Agilent ESI Tuning Mix, G2421, Agilent Technologies) through a 4000 QTRAP® System modified substantially as described above with reference to FIGS. 5A-C. To obtain the mass spectra of FIGS. 6A-D, however, an RF signal of 283 V₀₋ₚ was applied to the quadrupole rods (still maintained at a −10V DC offset). The experimental conditions of FIGS. 6A-D further differs in that rather than decreasing the voltage (i.e., making the auxiliary DC signal more negative relative to the −10V DC offset), the auxiliary DC voltage was adjusted away from the DC offset voltage by increasing the voltage of the auxiliary rods to 0V DC as in FIG. 6B (ΔV=10V DC relative to DC offset), +5V DC as in FIG. 6C (ΔV=+15V DC), and +9V DC as in FIG. 6D (ΔV=+19V DC). That is, compared to the quadrupole rods, the auxiliary electrodes were more repulsive to positive ions generated by the ion source. Comparing FIGS. 6A-6D, the multipole ion guides appear to better filter low m/z ions as the auxiliary electrodes become increasingly positive (i.e., more repulsive to positive ions) relative to the quadrupole electrodes. It will thus be appreciated that multipole ion guides in accordance with various aspects of the present teachings can be operated as a high-pass filter by making the auxiliary DC signal more positive, thereby potentially preventing interfering/contaminating low m/z ions from being transmitted to downstream mass analyzers.

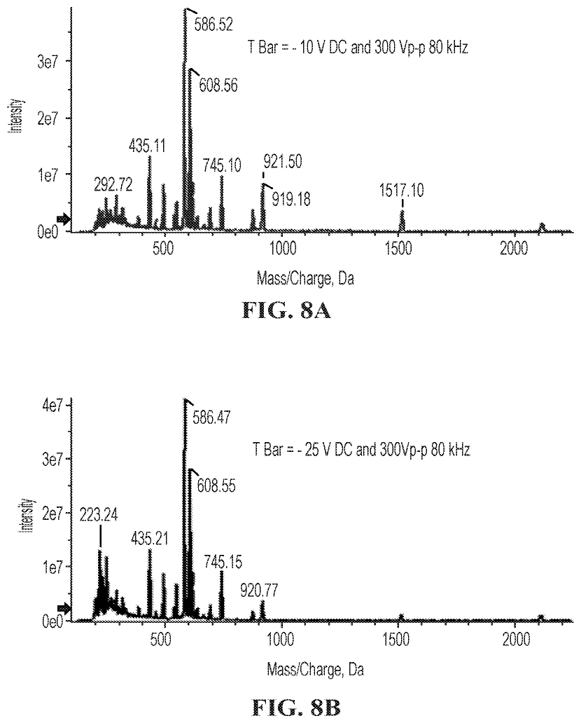

In accordance with various aspects, multipole ion guides in accordance with the present teachings can alternatively or additionally be coupled to an RF power supply such that an RF signal is applied to the auxiliary electrodes so as to control or manipulate the transmission of ions from the multipole ion guide 120 into the downstream vacuum chamber 114. With reference now to FIGS. 7A-C, exemplary mass spectra are depicted following transmission of an ionized standard (Agilent ESI Tuning Mix, G2421, Agilent Technologies) through a 4000 QTRAP® System modified in accordance with various aspects of the present teachings to include auxiliary T-shaped electrodes having a length of about 10 mm located about 12 cm downstream from the proximal, inlet end of the quadrupole rods of Q0 (which have a length of about 18 cm). The quadrupole rods of Q0 were maintained at a −10V DC offset, with an RF signal of 283 V₀₋ₚ being applied to the quadrupole rods. The frequency of the main drive RF applied to the quadrupole rods was approximately 1 MHz, with the signals applied to adjacent quadrupole rods being opposite in phase to one another.

To generate the mass spectrogram of FIG. 7A, the auxiliary electrodes were maintained at −10V DC (i.e., at the same DC offset voltage of quadrupole rods) such that the multipole ion guide substantially functioned as a conventional collimating quadrupole (i.e., no auxiliary RF signal was applied). For FIG. 7B, the auxiliary DC voltage was also maintained at −10V DC, though an identical auxiliary RF signal was applied to each of the auxiliary electrodes (e.g. the four electrodes 140 of FIGS. 2 and 3) at 300 Vₚ₋ₚ at a frequency of 80 kHz. Similarly, for FIG. 7C, the auxiliary DC voltage was maintained at −10V DC and an identical auxiliary RF signal was applied to each of the auxiliary electrodes at 350 Vₚ₋ₚ at a frequency of 80 kHz. In comparing FIGS. 7A-C, it is observed that the increasing the amplitude of the RF signal applied to the auxiliary electrodes can be increasingly effective to remove high m/z ions from the mass spectrum, with little to no effect on the low m/z portion of the spectrum. For example, while identifiable peaks are present in FIG. 7A at 2116.22 Da, this peak is largely attenuated in FIG. 7B. In comparing FIG. 7C to FIG. 7B (after increasing the amplitude of the auxiliary RF signal to 350 Vₚ₋ₚ from 300 Vₚ₋ₚ), it is observed that high m/z ions are further filtered. For example, while identifiable peaks are present in FIG. 7B at 920.77 Da and 1522.36 Da, these peaks are absent in FIG. 7C. Indeed, there is no discernible signal in FIG. 7C beyond about 900 Da. It will thus be appreciated that in multipole ion guides in accordance with various aspects of the present teachings, the RF signal applied to the auxiliary electrodes can be adjusted to prevent high m/z ions from being transmitted to downstream mass analyzers, thereby potentially preventing the effects of interfering/contaminating ions present in the ions generated by ion source.

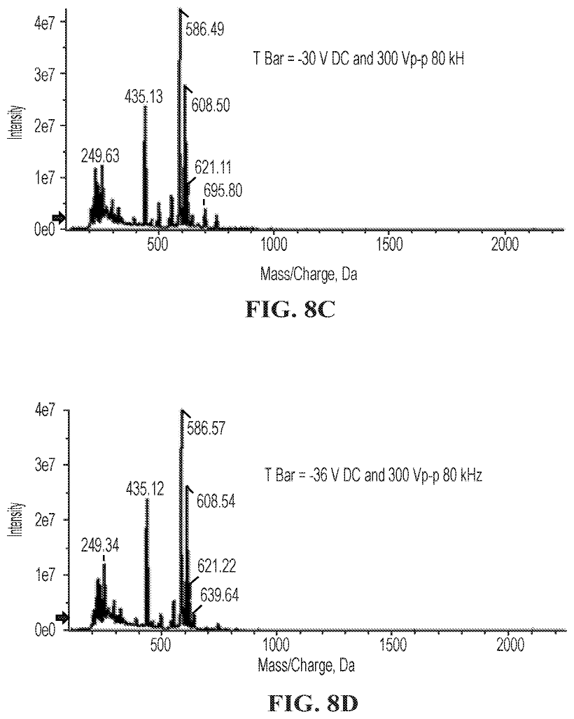

Further, in accordance with various aspects of the present teachings, both the auxiliary DC signal and auxiliary RF signal applied to the auxiliary electrodes can be adjusted so as to control or manipulate the transmission of ions from the multipole ion guide. With reference now to FIG. 7A and FIGS. 8A-F, the exemplary mass spectra depict the effect of adjustments to both the DC and RF auxiliary signals. As noted above, to generate the mass spectrogram of FIG. 7A, the auxiliary electrodes were maintained at −10V DC (i.e., at the same DC offset voltage of quadrupole rods) such that the multipole ion guide substantially functioned as a conventional collimating quadrupole (i.e., no auxiliary RF signal was applied). In FIG. 8A (which is identical to FIG. 7B), the auxiliary DC voltage was maintained at −10V DC, though an identical auxiliary RF signal at 300 Vₚ₋ₚ at a frequency of 80 kHz was applied to each of the auxiliary electrodes. For the ion spectra of FIGS. 8B-E, the auxiliary RF signal was maintained at 300 Vₚ₋ₚ at a frequency of 80 kHz, while the auxiliary DC voltage applied to the electrodes was respectively decreased as follows: −25V DC as in FIG. 8B (ΔV=−15V DC relative to DC offset); −30V DC as in FIG. 8C (ΔV=−20V DC); −36V DC as in FIG. 8D (ΔV=−26V DC); −38V DC as in FIG. 8E (ΔV=−28V DC); and −45V DC as in FIG. 8F (ΔV=−35V DC). It will be appreciated by a person skilled in the art in light of the accompanying data and the present teachings that both the RF and DC auxiliary signals can be adjusted (e.g., tuned) so as to provide the desired filtering by multipole ion guides in accordance with various aspects described herein. By way of non-limiting example, it will be appreciated that the data of FIG. 8A-F demonstrate that the application of the RF signal can reduce the amplitude of the auxiliary DC voltage required for filtering of the high m/z ions, while the low m/z ions remain largely unaffected (compare FIG. 5C which depicts substantial low m/z removal at an auxiliary DC voltage of −19V DC (ΔV=−9V DC relative to DC offset)).

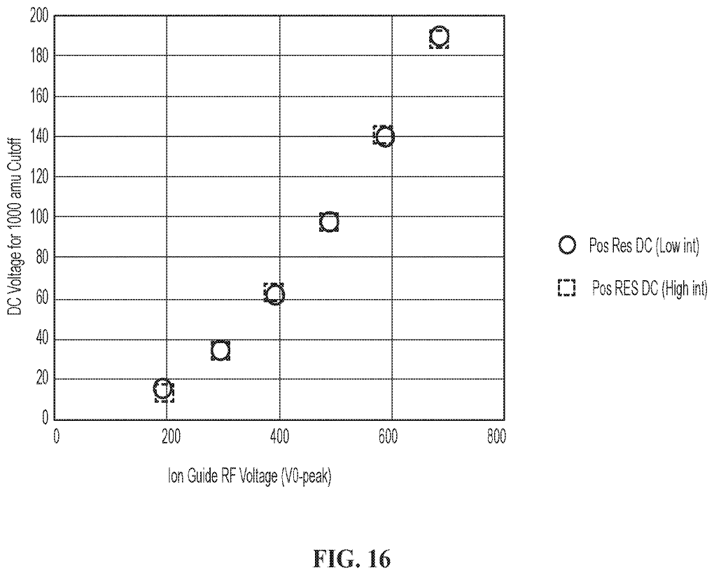

With reference now to FIG. 16, exemplary data is depicted demonstrating a DC voltage that was applied to auxiliary electrodes of an RF/DC filter to provide a high m/z cutoff at 1000 amu. The graph in FIG. 16 exhibits data that was acquired using an auxiliary electrode biasing arrangement as shown in FIG. 14.

The two data sets of FIG. 16 correspond to an applied auxiliary electrode voltage difference relative to a DC offset voltage of an RF ion guide voltage. The applied auxiliary electrode voltage difference shown is the additional voltage that was applied to the auxiliary electrodes relative to a DC offset voltage for an RF ion guide voltage. For example, A 60 volt DC voltage correlates to 60 volts applied on top of a DC offset of an RF ion guide. The voltage applied to the auxiliary electrodes above that of a DC offset voltage for an RF ion guide voltage produces a m/z cutoff at 1000 amu.

As above explained for the arrangement of FIG. 14, the additional voltage is applied with the same amplitude to each pair of the two pairs of auxiliary electrodes with one pair biased negative and another pair biased positive. For example, a 60 volt DC voltage correlates to +60 volts applied on top of a DC offset of an RF ion guide applied to one radially opposite pair of auxiliary electrodes and −60 volts applied on top of a DC offset of an RF ion guide applied to the other radially opposite pair of auxiliary electrodes.

The two data sets represent two different ion intensities, specifically differences in ion bean intensity of more than 10×.

The data shows DC voltages applied to auxiliary electrodes of an RF/DC filter achieve a high m/z cutoff of 1000 amu for different ion intensities. For each set RF ion guide voltage and each set auxiliary electrode voltage, a high m/z cutoff of 1000 amu is achieved for both high ion beam intensity and low ion beam intensity. That is, in this example, despite ion beam intensity differences, DC voltage values of additional DC voltage for auxiliary electrodes that result in a 1000 amu cutoff are virtually identical for both sets of ion beam intensity data.

FIG. 16 shows that an RF/DC filter using an alternate biasing of auxiliary electrodes as provided herein significantly minimizes ion current-induced changes in the high m/z cutoff.

Those skilled in the art will know or be able to ascertain using no more than routine experimentation, many equivalents to the embodiments and practices described herein. By way of example, the dimensions of the various components and explicit values for particular electrical signals (e.g., amplitude, frequencies, etc.) applied to the various components are merely exemplary and are not intended to limit the scope of the present teachings. Accordingly, it will be understood that the invention is not to be limited to the embodiments disclosed herein, but is to be understood from the following claims, which are to be interpreted as broadly as allowed under the law.

The present disclosure is not limited to the embodiments described and exemplified above, but is capable of variation and modification within the scope of the appended claims. The section headings used herein are for organizational purposes only and are not to be construed as limiting. While the applicant's teachings are described in conjunction with various embodiments, it is not intended that the applicant's teachings be limited to such embodiments. On the contrary, the applicant's teachings encompass various alternatives, modifications, and equivalents, as will be appreciated by those of skill in the art.

Various publications, including patents, published applications, technical articles and scholarly articles are cited throughout the specification. Each of these cited publications is incorporated by reference herein, in its entirety and for all purposes.

### Other Embodiments And Equivalents

While the present disclosure has explicitly discussed certain particular embodiments and examples of the present disclosure, those skilled in the art will appreciate that the disclosure is not intended to be limited to such embodiments or examples. On the contrary, the present disclosure encompasses various alternatives, modifications, and equivalents of such particular embodiments and/or example, as will be appreciated by those of skill in the art.

Accordingly, for example, methods and diagrams of should not be read as limited to a particular described order or arrangement of steps or elements unless explicitly stated or clearly required from context (e.g., otherwise inoperable). Furthermore, different features of particular elements that may be exemplified in different embodiments may be combined with one another in some embodiments.

What is claimed is:

1. A mass spectrometry system, comprising:
an ion source for generating ions;
an ion guide chamber positioned downstream of said ion source for receiving said ions, the ion guide chamber comprising:
an inlet orifice for receiving the ions generated by the ion source; and
at least one exit orifice for transmitting ions from the ion guide chamber into a vacuum chamber housing at least one mass analyzer;
a multipole ion guide disposed in the ion guide chamber, the multipole ion guide comprising:
a quadrupole rod set extending from a proximal end disposed adjacent the inlet orifice to a distal end disposed adjacent the at least one exit orifice, the quadrupole rod set comprising a first pair of rods and a second pair of rods, wherein each rod is spaced from and extends alongside a central longitudinal axis,
a plurality of auxiliary electrodes spaced from and extending alongside the central longitudinal axis along at least a portion of the quadrupole rod set, wherein at least one auxiliary electrode of the plurality of auxiliary electrodes is interposed between each of the rods of the quadrupole rod set such that each of the auxiliary electrodes is adjacent to a single rod of the first pair of rods and a single rod of the second pair of rods, and
at least one power supply coupled to the multipole ion guide operable to provide
i) a first RF voltage applied to the first pair of rods at a first frequency and in a first phase,
ii) a second RF voltage applied to the second pair of rods at a second frequency equal to the first frequency and in a second phase opposite to the first phase, and
iii) a plurality of auxiliary electrical signals applied to the auxiliary electrodes, comprising:
a) a first DC voltage applied to a first pair of the auxiliary electrodes, and
b) a second DC voltage applied to a second pair of the auxiliary electrodes,
wherein the first and second applied DC voltages have opposite signs.

2. The mass spectrometry system of claim 1, wherein the first and second applied DC voltages have substantially the same amplitude.

3. The mass spectrometry system of claim 1, wherein each of said first and second pairs of the auxiliary electrodes comprises two electrodes that are arranged radially opposite from one another in relation to the central longitudinal axis.

4. The mass spectrometry system of claim 3, wherein said first and second pairs of the auxiliary electrodes are arranged such that each auxiliary electrode of each pair is positioned adjacent to two auxiliary electrodes of the other pair.

5. The mass spectrometry system of claim 1, wherein the ion guide chamber is maintained at a pressure in a range from about 1 mTorr to about 30 mTorr.

6. The mass spectrometry system of claim 1, wherein the at least one power supply comprises:
at least one RF voltage source operable to apply the first RF voltage to the first pair of rods and the second RF voltage to the second pair of the rods;
at least one DC voltage source operable to apply a DC offset voltage to at least one of said quadrupole rod sets,
a first auxiliary DC voltage source operable to apply a DC voltage to the first pair of auxiliary electrodes; and
a second auxiliary DC voltage source operable to apply a DC voltage to the second pair of auxiliary electrodes.

7. The mass spectrometry system of claim 1, wherein a magnitude of the first and second applied auxiliary DC voltages is different from said DC offset voltage.

8. The mass spectrometry system of claim 1, further comprising at least one controller.

9. The mass spectrometry system of claim 8, wherein the at least one controller can be configured to adjust the first and second applied auxiliary DC voltages to the auxiliary electrodes.

10. The mass spectrometry system of claim 9, wherein the at least one controller can be configured to adjust the first and second auxiliary DC voltages applied to the auxiliary electrodes relative to a DC offset voltage applied to at least one of said quadrupole rod sets so as to attenuate ions transmitted from the multipole ion guide.

11. The mass spectrometry system of claim 9, wherein the at least one controller can be configured to adjust first and second applied auxiliary DC voltages relative to a DC offset voltage at which the quadrupole rod set is maintained so as to filter ions and/or cutoff ions transmitted from the multipole ion guide.

12. The mass spectrometry system of claim 1, wherein the auxiliary electrodes of the plurality of auxiliary electrodes are characterized by a length, and wherein each of the auxiliary electrodes' length is less than a length of the pairs of rods of the quadrupole rod set.

13. The mass spectrometry system of claim 11, wherein the ion source can be configured to generate ions at a plurality of ion intensities.

14. The mass spectrometry system of claim 1, wherein said auxiliary DC voltages have a magnitude in a range of about ±1 V to about ±200 V.

15. The mass spectrometry system of claim 1, wherein each of said first and second RF voltages has an amplitude in a range of about 50 V to about 1000 V and a frequency in a range of about 0.3 MHz to about 2.5 MHz.

16. A mass spectrometry system, comprising:
an ion source for generating ions;
an ion guide chamber, the ion guide chamber comprising:
an inlet orifice for receiving the ions generated by the ion source; and
at least one exit orifice for transmitting ions from the ion guide chamber into a vacuum chamber housing at least one mass analyzer;
a multipole ion guide disposed in the ion guide chamber, the multipole ion guide comprising:
a quadrupole rod set extending from a proximal end disposed adjacent the inlet orifice to a distal end disposed adjacent the at least one exit orifice, the quadrupole rod set comprising a first pair of rods and a second pair of rods, wherein each rod is spaced from and extends alongside a central longitudinal axis, and
an auxiliary electrode assembly comprising a plurality of auxiliary electrodes radially spaced from and extending alongside along at least a portion of the central longitudinal axis, the plurality of auxiliary electrodes comprising a plurality of electrically conductive stems having a length of about 5 mm to about 20 mm interposed and extending between rods of the quadrupole rod set such that each stem of the auxiliary electrodes is adjacent to a single rod of the first pair of rods and a single rod of the second pair of rods,
at least one power supply coupled to the multipole ion guide operable to provide
i) a first RF voltage to the first pair of rods at a first frequency and in a first phase,
ii) a second RF voltage to the second pair of rods at a second frequency equal to the first frequency and in a second phase opposite to the first phase, and
iii) an auxiliary electrical signal applied to the auxiliary electrode assembly.

17. The mass spectrometry system of claim 16, wherein the auxiliary electrode assembly has a thickness in a range of about 0.1 mm to about 50 mm.

18. A method of processing ions, comprising the steps of:
receiving ions generated by an ion source through an inlet orifice of an ion guide chamber;
transmitting ions through a multipole ion guide disposed in the ion guide chamber, the multipole ion guide comprising:
a quadrupole rod set extending from a proximal end disposed adjacent the inlet orifice to a distal end disposed adjacent at least one exit orifice, the quadrupole rod set comprising a first pair of rods and a second pair of rods, wherein each of said rods is spaced from and extends alongside a central longitudinal axis,
a plurality of auxiliary electrodes spaced from and extending alongside the central longitudinal axis along at least a portion of the quadrupole rod set, wherein at least one auxiliary electrode of the plurality of auxiliary electrodes is interposed between each of the rods of the quadrupole rod set such that each of the auxiliary electrodes is adjacent to a single rod of the first pair of rods and a single rod of the second pair of rods, and
at least one power supply coupled to the multipole ion guide;
applying a first RF voltage to the first pair of rods at a first frequency and in a first phase;
applying a second RF voltage to the second pair at a second frequency equal to the first frequency and in a second phase opposite to the first phase;
applying a first auxiliary DC voltage to a first pair of the auxiliary electrodes;
applying a second auxiliary DC voltage to a second pair of the auxiliary electrodes voltage having a same voltage and an opposite sign relative to the first DC voltage; and
transmitting ions from the ion guide chamber through the at least one exit orifice into a vacuum chamber housing at least one mass analyzer.

19. The method of claim 18, wherein the steps of applying the first auxiliary DC voltage and applying the second auxiliary DC voltage comprises applying a DC voltage having an amplitude that is different from a DC offset voltage at which the quadrupole rod set is maintained.

20. The method of claim 18, further comprising adjusting the first and second auxiliary DC voltages provided to the auxiliary electrodes so as to generate a m/z cutoff of ions transmitted from the multipole ion guide.

21. The method of claim 18, wherein the multipole ion guide is characterized such that when the ion source generates ions at more than one ion intensity, a substantially same amplitude of the first and second applied auxiliary DC voltages generates a cutoff off that limits transmission from the multipole ion guide of selected ions according their m/z at each ion intensity of the more than one ion intensity.
